(19) United States
(12) Patent Application Publication
(10) Pub. No.: US 2018/0084380 A1
(43) Pub. Date: Mar. 22, 2018

(54) ENHANCED LOCALITY COMMUNICATION SYSTEM

(71) Applicant: WATCH OUT!, INC., Del Mar, CA (US)

(72) Inventor: Michael T. Lucas, Del Mar, CA (US)

(21) Appl. No.: 15/792,715

(22) Filed: Oct. 24, 2017

Related U.S. Application Data
(63) Continuation-in-part of application No. 14/946,013, filed on Nov. 19, 2015.
(60) Provisional application No. 62/116,349, filed on Feb. 13, 2015.

(51) Int. Cl. H04W 4/02; H04W 68/02

(52) U.S. Cl. CPC H04W 4/021; H04W 4/023; H04W 68/02

(57) ABSTRACT

Methods and systems including computer program products for providing a mobile device with relevant content about products. The method includes receiving several electronic communications regarding several product identifiers, storing the several electronic communications in a product notification database, extracting one or more electronic communications containing the relevant product content, and withholding from the mobile device and maintaining at the product notification database the several stored electronic communications not extracted. Extracting further includes obtaining a geo-fenced location from the mobile device, looking up a business class for the geo-fenced location, scanning the several electronic communications for product identifiers matching the business class, flagging one or more electronic communications regarding product identifiers matching the business class, creating a product alert from the one or more flagged electronic communications and transmitting the alert to the mobile device.

### CROSS REFERENCE TO RELATED APPLICATIONS

This application is a continuation-in-part of U.S. patent application Ser. No. 14/946,013 filed on Nov. 19, 2015, which claims the benefit of U.S. Prov. Pat. App. No. 62/116,349 filed on Feb. 13, 2015, the entireties of which are hereby incorporated by reference.

### BACKGROUND

This disclosure relates to the general field of networked mobile devices, and more specifically toward methods and systems including computer program products for providing a mobile device with relevant content about products, services and other geographic and time dependent information. The method includes receiving several electronic communications regarding several product identifiers, storing the several electronic communications in a product notification database, extracting one or more electronic communications containing the relevant content, and providing relevant notifications to a mobile device. Extracting further includes obtaining a geo-fenced location from the mobile device, looking up a business class for the geo-fenced location, scanning the several electronic communications for product identifiers matching the business class, flagging one or more electronic communications regarding product identifiers matching the business class, creating a product alert from the one or more flagged electronic communications and transmitting the alert to the mobile device.

Recalls, safety notifications, bulletins, and other consumer health safety related matters are published by government websites throughout the world. These recalls, safety notifications and bulletins concern consumer products including but not limited to automobiles, foods, beverages, electronics, appliances and prescription as well as non-prescription medicines. While the rise of the Internet and the information age has, on one hand, greatly improved consumer accessibility to information about recalls and alerts, the terrific proliferation of available data has increased the responsibilities of the diligent consumer. The tremendous amount of information, product constituents, dynamic points of distribution, inability to track or induce compliance and the inability to adapt to the individual needs of the users has created a significant technical problem of such proportion that the consumer can no longer make use of the burdensome relevant information. The resulting disconnect between consumers and the information useful to them regarding potentially tainted, defective, expired, warrantied, allergen or recalled products has left consumers exposed to health and safety risks.

The same technical problem extends to service related users as well, where in one example, utility disruptions are currently reported via email campaigns or websites such that an active search returns the latest, most relevant news sent to consumers who are likely not affected by the disruption. A like technical issue exists in that the dynamics of service provision results in a flood of information whose volume and lack of immediate relevance creates a disconnect between users and the information useful to them regarding service disparity, maintenance, outages effecting relatives, emergency situations, brown-out timings or service loading, which has left consumers exposed to health and safety risks.

Thus there has existed a long-felt need for systems and methods for providing mobile devices with information directly relevant to the mobile device user in a timely fashion.

### SUMMARY

The current disclosure provides just such a solution by having methods and systems including computer program products for providing a mobile device with relevant content about products, services and other geographic and time dependent information. The method includes receiving several electronic communications regarding several product identifiers, storing the several electronic communications in a product notification database, extracting one or more electronic communications containing the relevant content, and providing relevant notifications to a mobile device. Extracting further includes obtaining a geo-fenced location from the mobile device, looking up a business class for the geo-fenced location, scanning the several electronic communications for product identifiers matching the business class, flagging one or more electronic communications regarding product identifiers matching the business class, creating a product alert from the one or more flagged electronic communications and transmitting the alert to the mobile device.

One aspect of the present disclosure seeks to provide methods, systems and apparatuses for providing a mobile device with information directly relevant to the mobile device user in a timely fashion using multiple computational devices structured to use a close approximation of a common time, a communication network structured to exchange information between said computational devices, a display mechanism controlled by one of said computational devices to display notifications wherein said notification is initiated by detection of a mobile devices ingress of a predetermined location, at least one determination of data relevant to said mobile device user and a hierarchical classification of location type where location type is defined by recurrent data updates of location groups as well as dynamic updates of individual locations and where display of said notification is based on exclusionary parameters. The method includes executing on one or more processors the steps of storing a data set defining a first geo-fenced location associated with at least one classification chosen from amongst a hierarchy of classifications and related notices from a product database, wherein the association of one or more received notices regarding products is based in part on information previously stored in one or more of the at least one classification amongst the hierarchy of classifications which has been previously associated with a first geo-fenced location, assembling a first set of relevant information based on one or more product database updates associated with at least one classification amongst a hierarchy of classifications associated with the first geo-fenced location, and in response to receiving from a mobile device a an indication of ingress of the first geo-fenced location, transmitting relevant information based on a hierarchy of location classifications, feedback from locations within the classification hierarchy, notices regarding products, content and displaying said information on said mobile device based on exclusionary data.

Additionally other aspects of the present disclosure seeks to provide methods, systems and apparatuses for providing a mobile device with information directly relevant to the mobile device user in a timely fashion using multiple computational devices structured to use a close approximation of a common time, a communication network structured to exchange information between said computational devices, a display mechanism controlled by one of said computational devices to display notifications wherein said notification is imitated by detection of a mobile devices ingress of a predetermined location, at least one determination of data relevant to said mobile device user and a hierarchical classification of location type where location type is defined by recurrent data updates of location groups as well as dynamic updates of individual locations and exclusionary parameters. The method includes executing on one or more processors the steps of storing a data set defining a first geo-fenced location associated with at least one classification chosen from amongst a hierarchy of classifications and related notices from a product database, wherein the association of one or more received notices regarding products is based in part on information previously stored in one or more of the at least one classification amongst the hierarchy of classifications which has been previously associated with a first geo-fenced location, assembling a first set of relevant information based on one or more product database updates associated with at least one classification, amongst a hierarchy of classifications, associated with the first geo-fenced location, and in response to receiving from a mobile device an indication of ingress of the first geo-fenced location, transmitting relevant information based on a hierarchy of location classifications, feedback from locations within the classification hierarchy, notices regarding products, content and based on exclusionary data.

Additionally, other aspects of the present disclosure seek to provide methods systems and apparatuses for providing a mobile device with information directly relevant to the mobile device user in a timely fashion using multiple computational devices structured to use a close approximation of a common time, a communication network structured to exchange information between said computational devices, a display mechanism controlled by one of said computational devices to display notifications wherein said notification is initiated by detection of a mobile devices similarity to a predetermined pattern of use, at least one determination of data relevant to said mobile device user and a hierarchical classification of use type where use type is defined by recurrent data updates of use groups as well as dynamic updates of individual use and exclusionary parameters. The method includes executing on one or more processors the steps of storing a data set defining a first geo-fenced location associated with at least one classification chosen from amongst a hierarchy of classifications and related notices from a product database, wherein the association of one or more received notices regarding products is based in part on information previously stored in one or more of the at least one classification amongst the hierarchy of classifications which has been previously associated with a similarity to a predetermined pattern of use, assembling a first set of relevant information based on one or more product database updates associated with at least one classification, amongst a hierarchy of classifications, associated with the similarity to a predetermined pattern of use, and in response to receiving from a mobile device an indication of similarity to a predetermined pattern of use, transmitting relevant information based on a hierarchy of pattern of use classifications and feedback from users in response to classifications.

It is an object of the current disclosure to provide a system for providing notices relevant to a user of a particular mobile device based upon location and time identifications.

It is another object of the current disclosure to provide a method for providing notices relevant to a user of a particular mobile device based upon location and time identifications.

It is a further object of the current disclosure to provide system architectures to enable the efficient transmission of notifications relevant to a user of a particular mobile device based upon location and time identifications.

It is yet another object of the current disclosure to provide information to users when in close proximity to critical conditions.

It is an additional object of the current disclosure to provide information to users validated by close proximity to known locations of source and known locations of destination.

It is another object of the current disclosure to provide information regarding user's historical proximity to critical conditions.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future. Furthermore, the use of plurals can also refer to the singular, including without limitation when a term refers to one or more of a particular item; likewise, the use of a singular term can also include the plural, unless the context dictates otherwise.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

As used herein, the term “product” shall include goods, services, points of interest or information, and any combination thereof; the term “network connected device” is any device that is in network communication with one or more other devices; the term “relate” and its derivations include both direct and indirect relation, for example, if A is related to C, A may be directly related to C, or A may be related to B, and B may be related to C, in which case A is indirectly related to C; the term “matches” means that two related values, data, or data sets are functionally equivalent, for example, when two identifiers refer to the same logical reference item even though the physical underlying data may not be identical.

Certain embodiments of the current disclosure include a system comprising one or more processors executing programming logic, the programming logic configured to: store geographic boundary data comprising a plurality of geographic boundary data sets, where each geographic boundary data set indicates the boundaries of a physical space and has or is associated with a location identifier; receive location data from a network connected device, where the location data comprises data indicating a location of the network connected device and a unique identifier of the network connected device, determine one or more location identifiers, if any, utilizing the location data and the geographic boundary data, where each location identifier relates to one or more classes, where each class relates to one or more source identifiers; select one or more notifications, where each notification indicates one or more issues associated with a source identifier, where each source identifier of each notification relates to at least one source identifier related to at least one of the classes related the one or more location identifiers; assemble an alert utilizing the selected one or more notifications; and transmit the alert to the network connected device. The programming logic is further configured to: receive or obtain the one or more notifications from one or more remote devices. The programming logic is further configured to: transmit location parameters to the network connected mobile device thereby enabling the network connected device to transmit location data based on the location parameters. The one or more sources are selected from the group consisting of products and services. The programming logic is further configured to: receive feedback data from the network connected device, where the feedback data comprises a source identifier. The programming logic of assembling an alert utilizing the selected one or more notifications is further configured to: withhold from the alert any notifications identified utilizing one or more filter parameters received from the network connected device. Each class has a class identifier, wherein the programming logic is further configured to: receive feedback data from the network connected device, where the feedback data comprises a class identifier. The programming logic is further configured to: receive feedback data from the network connected device, where the feedback data comprises a location identifier. The boundaries of a physical space indicated by each geographic boundary data set indicate a two-dimensional area. The boundaries of a physical space indicated by each geographic boundary data set are defined by a polygon with vertices indicated by GPS coordinates. The location data further comprises a timestamp, where the timestamp indicates a time, relative or absolute, at which the network connected device was at the location indicated by the location data. The programming logic is further configured to: receive additional location data from the network connected device; and determine an absence of one or more location identifiers previously determined, if any, utilizing the additional location data and the geographic boundary data. The programming logic is further configured to: receive from a remote device a request to remove a notification; and remove the notification.

Further embodiments of the current disclosure include a non-transitory computer-readable medium, comprising instructions stored thereon, that when executed on one or more processors, perform the steps of: receiving geographic location data and a unique identifier from a network connected device; determining if the geographic location data indicates that the network connected device is within a distance of a certain location, and if so determined, associating the unique identifier of the network connected device with a timestamp and a location identifier, where the location identifier relates to the certain location, where the location identifier relates to one or more classes of sources, and where each class of sources relates to one or more source identifiers; selecting one or more notifications, where each notification indicates an issue associated with a source identifier, where each source identifier of each notification relates to at least one of the one or more source identifiers related to at least one of the classes of sources related the location identifier related to the certain location; and transmitting the selected one or more notifications to the network connected device. The geographic location data comprises GPS coordinates. The instructions stored thereon, when executed on one or more processors, further perform the step of: transmitting location parameters to the network connected mobile device thereby enabling the network connected device to transmit location data based on the location parameters. The instructions stored thereon, when executed on one or more processors, further perform the step of: receiving additional geographic location data and the unique identifier from the network connected device, determining if the additional location data indicates that the network connected device is outside the distance of the certain location, and if so determined, associating the unique identifier of the network connected device with a second timestamp and the location identifier. The instructions stored thereon, when executed on a processor, further perform the step of: calculating a duration, where the duration is a difference between the timestamp and the second timestamp. The timestamp and the second timestamp are provided by the network connected device. The instructions stored thereon, when executed on one or more processors, further perform the steps of: receiving feedback data from a second network connected device, where the second network connected device has a constant location identifier, where the feedback data comprises a source identifier; and withholding transmitting to the network connected device any notifications having an associated source identifier that matches the source identifier from the feedback data and having an associated source identifier that is related to at least one of the classes of sources related to the location identifier that matches the constant location identifier.

Embodiments of the current disclosure also include a method of enhanced location-based communications comprising the steps of: transmitting location parameters to a network connected device, where the location parameters include data indicating when, where, or both when and where location data should be transmitted; receiving location data from the network connected device; determining if the location data indicates that the network connected device is within a geographic boundary defined by a geographic boundary data set, where the geographic boundary data set has or is associated with a location identifier; selecting one or more notifications, where each notification indicates one or more issues associated with a source identifier, where each source identifier of each notification relates to one or more source identifiers of one or more classes of sources, where each class of sources relates to the location identifier; and transmitting the selected one or more notifications to the network connected device. The location parameters comprise a plurality of geographic boundary data sets; or the location parameters comprise a plurality of proximity data sets, where each proximity data set comprises a location point, a radius, and a transmission rate. The location data received from the network connected device comprises the location identifier. The method further comprises the steps of receiving feedback data from a second network connected device, where the second network connected device has a constant location identifier, where the feedback data comprises a source identifier; and withholding transmitting to the network connected device any notifications having an associated source identifier that matches the source identifier from the feedback data and having an associated source identifier that is related to at least one of the classes of sources related to the location identifier that matches the constant location identifier. The method further comprises the step of receiving feedback data from the network connected device, where the feedback data comprises a source identifier and the location identifier.

There has thus been outlined, rather broadly, the more important features of the invention in order that the detailed description thereof may be better understood, and in order that the present contribution to the art may be better appreciated. There are additional features of the invention that will be described hereinafter and which will also form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is schematic illustration of an example network environment that is suitable for practicing embodiments of the present disclosure.

FIG. 2 is a schematic illustration of various components of a product notification server, in accordance with an embodiment of the present disclosure.

FIG. 3 is a schematic illustration of various components of a data processing unit, in accordance with an embodiment of the present disclosure.

FIG. 4 illustrates a flow diagram of an example method for providing a mobile device with relevant content about products according to selected embodiments of the current disclosure.

FIG. 5 illustrates a flow diagram of an example process for extracting communications with relevant content according to selected embodiments of the current disclosure.

FIG. 6 illustrates a flow diagram of an example process for obtaining a geo-fenced location and computing a duration of a consumer's stay according to selected embodiments of the current disclosure.

FIG. 7 schematically illustrates a user's path through a plurality of geo-fenced business establishments according to selected embodiments of the current disclosure.

FIG. 8 illustrates a flow diagram of an example process for verifying user reviews according to selected embodiments of the current disclosure.

FIG. 9 illustrates a flow diagram of a second example method for providing a mobile device with relevant product content according to selected embodiments of the current disclosure.

FIG. 10 schematically illustrates a user's path through a number of geo-fenced locations within a geo-fenced business establishment according to selected embodiments of the current disclosure.

FIG. 11 illustrates a flow diagram of an example method for influencing protective alerts with user feedback in accordance with selected embodiments of a computer-implemented method for providing a mobile device with relevant content.

FIG. 12 illustrates an example of a graphical user interface usable with selected embodiments disclosed herein of systems for interacting with a relevant content delivery service.

FIG. 13 illustrates a flow diagram for providing a mobile device with relevant conditions according to selected embodiments of the current disclosure.

FIG. 14 illustrates a flow diagram of an example process for influencing relevant content with feedback from a business administrator in accordance with selected embodiments of the current disclosure.

FIG. 15 illustrates a flow diagram of an example process for receiving a geo-fenced location and computing a duration of a consumer's stay according to selected embodiments of the current disclosure.

FIG. 16 illustrates a flow diagram of an example process for verifying user claim for credit according to selected embodiments of the current disclosure.

FIG. 17 illustrates a flow diagram of an example of a related computer-implemented method for protecting a mobile device from inappropriate product content according to selected embodiments of the current disclosure.

FIG. 18 is an illustration of an example structure that is suitable for practicing a vicinity based cautioning embodiment of the present disclosure.

FIG. 19 is an illustration of an example structure that is suitable for practicing a data source validation embodiment of the present disclosure.

FIG. 20 is an illustration of an example structure that is suitable for practicing a data recipient validation embodiment of the present disclosure.

FIG. 21 is an illustration of an example structure that is suitable for practicing a disease vector embodiment of the present disclosure.

### DETAILED DESCRIPTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

In order to watch out for consumers, the presently disclosed methods employ the presently disclosed systems to organize data already currently publically available through government agencies such as manufacturer recalls, health safety notices, travel alerts, etc. These data are then delivered to a mobile device when the mobile device enters a geo-fenced area correlated to the recall, notice or alert through the present systems and one or more business registries, such as government business registries. Because the information necessary to alert consumers is already in the public domain, no permission from manufacturers or business owners is needed. Organized data is simply being delivered to consumer users who have registered to benefit from a relevant content delivery service.

Today mobile phones are configured to receive and present wireless emergency alerts to citizens regarding presidential emergencies, imminent threats to safety of life, and child abduction. These alerts are originated by an alerting authority such as Federal Agencies, State Governments, Territorial Governments, Tribal Governments and Local Governments, which are then authorized and transmitted by the Federal Emergency Management Agency (FEMA) to wireless providers and finally disseminated to mobile phones within a specified area and/or are triggered for a mobile phone upon entry into the specified area.

The information age has enabled global digital mapping. Physical addresses, such as those of restaurants and other businesses registered with a local government agency worldwide, are related in a database to the business type(s) for which the businesses are registered. For example, retailers, pharmacies, hospitals, restaurants and automotive businesses are identifiable as such in digital maps thanks to publically available data and successful search engines.

Products for which a recall, alert or incentive is made publicly available can be made to correspond to a physical business location that potentially sells, transfers, services, repairs or distributes the product according to the business type registered to the physical business location. The present service may, for example, alert a consumer who enters a business establishment to inform the consumer of one or more products currently on recall that are known to be carried by or are likely to be carried by the business.

Technology of the presently disclosed services and systems benefit consumers with a geo-fence around a particular address or location, for example that of a local grocery store. The geo-fenced location may be a region within a virtual boundary defined on a geographic area in accordance with rules programmed into the consumer mobile device, for example, by a downloaded client application. A mobile device with an active global positioning service periodically receives position information from one or more satellites or communication towers and records a geo-fence entry timestamp when the received position matches the region bounded by the geo-fence. This entry timestamp may then be transmitted from the mobile device to a server.

The consumer registers for the relevant content delivery service and initializes a consumer profile. One or more satellites forming part of a global positioning system and/or a beacon inform a consumer mobile device of present location using a location identifier. According to the present service, a central notification server receives the location identifier from the consumer mobile device so that select product notifications may be sent from a product notification database, through a communications network to the consumer mobile device. Relevant product recalls and notifications are automatically filtered to reduce the time a consumer needs to spend to make an informed decision about a product or service. With near instant delivery of relevant information, the presently disclosed services and systems enable delivery of relevant content to achieve a substantial reduction of health risks to consumers and liability of businesses.

No more consumer input than personal profile preferences and privacy requirements are required. While enabling concerned parties a more direct engagement, the consumer benefits from the incentives, promotions or monetary credits. Furthermore, the presently disclosed services and systems promote self-reporting by businesses and manufacturers to keep consumers informed and help prevent health safety issues, improve recall efficiencies, improve inventory management, and improve both product safety and processes to benefit everyday living.

In certain embodiments, the determination of entry into or exit from a particular geo-fenced location may occur on the user's mobile device. For example, the mobile device downloads from a centralized server system data that maps out or otherwise indicates the geographic boundaries of a geo-fenced location. The GPS enabled mobile device periodically obtains its current geographic position and then references the geo-fenced boundary data to determine whether an entry into our exit out of one or more geo-fenced locations occurred, and if so, records a timestamp and associates that timestamp with a geographic location indicator or a location identifier, together a location record, for subsequent transmission to a server system. The one or more location records data may be transmitted immediately thereafter, or stored for some period of time before transmission to a server system. Entry into a geo-fenced area is indicated if the immediately prior location record or records do not indicate that the mobile device is within the geo-fenced area, but the current location record indicates that the mobile device is within the geo-fenced area. Exit from a geo-fenced area is indicated if the immediately prior location record or records indicate that the mobile device was within the geo-fenced area, but the current location record indicates that the mobile device is not within the geo-fenced area. In other words, multiple locations records indicating a position within or out of a particular geo-fenced location may be required before an entry or exit, respectively, is indicated.

The data that maps out or otherwise indicates the geographic boundaries of a geo-fenced location that is downloaded to the mobile device may be limited in range. For example, instead of downloading all geo-fenced data available, a subset of that geo-fenced data is downloaded at periodic intervals. For example, the mobile device may provide its current geographic location to a remote server system, which then returns available geo-fenced data for areas within a one kilometer radius. At set intervals the mobile device may resend its current location, and if that location has changed, new geo-fenced data for areas within the revised one kilometer radius is provided. One skilled in the art after reading this disclosure should appreciate that the radius may be modified, or other geographic boundaries utilized, such as zip codes, city limits, county limits, or maximum data size limits.

Geographic boundaries can best be understood as proximity from one or more fixed locations. In the case of two locations A and B, a distance R1 can define a proximity from point A and distance R2 can define a proximity from point B. If point A is within the radius of R2 then the locations overlap which can be used to manage communication from a network connected device. If an individual enters the proximity of R2 from point B this can trigger the system to command the network connected device to report location at an increased rate, with greater accuracy or include other information not based on entry to geographic location B but because of the relevant importance of proximity to point A to the parameters of the network connected device.

In other embodiments, the determination of entry into or exit from a particular geographic location is initiated and determined by a signal received from a location indicating device. For example, a beacon, whose location is known to the system, transmits a wireless signal that is received by the mobile device, for example, using a Bluetooth® protocol. The signal includes a location identifier. Because of the limited range of the beacon's signal, for example a range of ten meters, the location of the mobile device is determined based upon its receipt of the signal from the beacon. Using the location identifier provided by the signal, the mobile device records a timestamp and associates the timestamp with the location identifier for subsequent transmission to a server system. Those skilled in the art after reading this disclosure should appreciate that other beacon systems using other wireless protocols and ranges may be utilized in accordance with the desired implementations of the system.

In yet other embodiments, the determination of entry into or exit from a particular geographic location is determined by a remote location system. The GPS enabled mobile device periodically obtains its current geographic position and associates that position with a timestamp. The timestamp and geographic position, together a location record, is transmitted to the remote location system. This location record may be transmitted immediately after it is obtained and recorded, or may be stored for some period of time before transmission to a server system, either one record at a time or as a part of multiple location records batched together. The remote location system has data that maps out or otherwise indicates the geographic boundaries of a geo-fenced location. The remote location system determines if a particular geographic record indicates an entry or exit into a geo-fenced location. Upon such a determination, it may return data to the mobile device indicating such exit or entry, or alternatively, act upon this information itself or send appropriate location data, for example, an identifier of the mobile device or user along with the location identifier and timestamp, to another server system.

The disclosed service may be offered free of cost or as a paid service with subscription-based billing or a transaction-based billing, such as pay-per-use and pay-per-feature.

According to embodiments of the present disclosure, a consumer user downloads a client application to their mobile device in the form of a computer program product, inventory of business registry establishments are initialized in a business profile, the consumer enters a geo-fenced establishment and receives a product notification which may include an alert regarding a tainted or potentially tainted product and/or an incentive, and a manager of the registered establishment changes inventory in the product notification database when potentially contaminated products are removed from the establishment or if the products were never present.

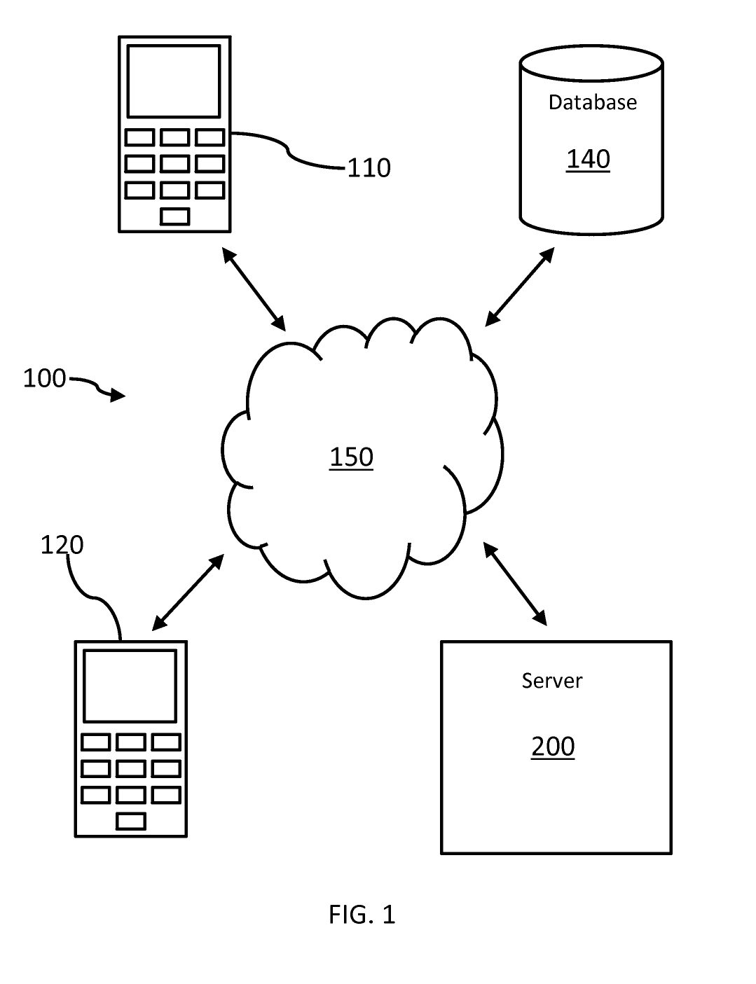

Referring now to the drawings, particularly by their reference numbers, FIG. 1 schematically illustrates an example network environment 100 suitable for practicing services and configuring systems of the present disclosure. Network environment 100 includes one or more data processing units, depicted as a data processing unit 110, and a data processing unit 120 in FIG. 1 and also includes a product notification server 200, a product notification database 140 associated with server 200 and a communication network 150.

Network environment 100 may be implemented in various ways, depending on various possible scenarios. In one example scenario, network environment 100 may be implemented by way of a spatially collocated arrangement of server 200 and database 140. In another example scenario, network environment 100 may be implemented by way of a spatially distributed arrangement of server 200 and database 140 coupled mutually in communication via communication network 150. In yet another example scenario, server 200 and database 140 may be implemented via cloud computing services.

Data processing units 110 and 120 are coupled in communication with server 200 via communication network 150. Communication network 150 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

Examples of data processing units 110 and 120 include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, Network-Attached Storage (NAS) devices, large-sized touch screens with embedded PCs, and interactive entertainment devices, such as game consoles, Television (TV) sets and Set-Top Boxes (STBs).

Optionally, data processing units 110 and 120 may access server 200 to download one or more software products associated with the relevant content delivery service. In one embodiment, a relevant content delivery system is arranged in a manner such that functionality is implemented partly in data processing units 110 and 120 and partly in server 200. For example, server 200 may operate a server-side application component of the system while data processing units 110 and 120 operate a client application component.

In another embodiment, the system is arranged in a manner such that its functionality is implemented substantially in data processing units 110 and 120 by way of downloaded client application software products. In such a scenario, data processing units 110 and 120 may be coupled to server 200 periodically or randomly from time to time, for example, to receive updates from server 200 and/or to upload status such as location, reviews and other feedback to server 200.

Users associated with data processing units 110 and 120 use the relevant product content extraction system. Accordingly, some of data processing units 110 may be used, operated, or carried by consumers, while some of data processing units 120 may be used, operated, or carried by business administrators, business establishment managers or some other entity having authority for managing customer and/or public relations.

FIG. 1 is merely an example embodiment, which should not unduly limit the scope of the claims herein. It is to be understood that the specific designation for network environment 100 is provided as an example and is not to be construed as limiting the network environment to specific numbers, types, or arrangements of data processing units, servers, databases and communication networks. A person skilled in the art will recognize many variations, alternatives, and modifications of embodiments of the present disclosure.

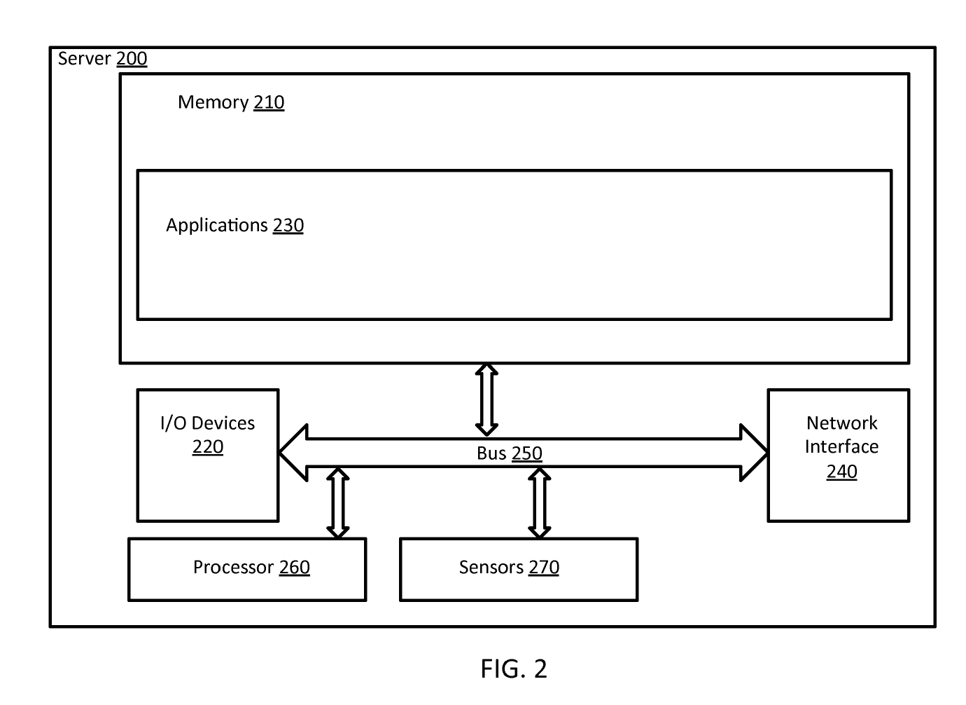

FIG. 2 is a schematic illustration of various components of a product notification server 200, in accordance with an example system of the present disclosure. Product notification server 200 includes, but is not limited to, a data memory 210 a computing hardware such as a processor 260, Input/Output (I/O) devices 220, a network interface 240, a configuration of sensors 270, and a system bus 250 that operatively couples various components including the data memory 210, the processor 260, the I/O devices 220, the network interface 240, and the sensors. The I/O devices 220 include a display screen for presenting graphical images to a user. Product notification server 200 also includes a power source for supplying electrical power to the various components thereof. The power source may, for example, include a rechargeable battery.

Data memory 210 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards. In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen.

Additionally or alternatively, I/O devices 220 include a mouse or a joystick operable to receive inputs corresponding to clicking, pointing, and/or moving a pointer object on the graphical user interface. I/O devices 220 may also include a keyboard operable to receive inputs corresponding to pushing certain buttons on the keyboard. Additionally, I/O devices 220 may also include a microphone for receiving an audio input from the user, and a speaker for providing an audio output to the user.

Moreover, sensors 270 may include one or more of: an accelerometer, a magnetometer, a pressure sensor, a temperature sensor, a gyroscopic sensor, a Global Positioning System (GPS) sensor, or a timer. Sensors 270 may be used to measure and collect data related to surroundings of the user. In some examples, a product notification management application may be interfaced with sensors 270. When executed on processor 260, the product notification management application is configured to resolve and integrate outputs of sensors 270 into useful information.

In some examples, sensors 270 may include a GPS sensor for determining one or more absolute spatial positions of the server upon a surface of the Earth. In some examples, one or more of sensors 270 may monitor government websites such as those managed by the U.S. Food and Drug Administration, the Food Safety and Inspection Service, Centers for Disease Control and Prevention or the U.S. Department of Health and Human Services for updates in order to collect recalls or other alerts.

Moreover, network interface 240 optionally allows Product notification server 200 to communicate with other data processing units, for example, via communication network 150.

Product notification server 200 is optionally implemented by way of at least one of: a mobile phone, a smart telephone, an MID, a tablet computer, a UMPC, a phablet computer, a PDA, a web pad, a PC, a handheld PC, a laptop computer, a desktop computer, an NAS device, a large-sized touch screen with an embedded PC, and an interactive entertainment device, such as a game console, a TV set and an STB.

FIG. 2 is merely an example embodiment, which should not unduly limit the scope of the claims herein. It is to be understood that the specific designation for product notification server 200 is provided as an example and is not to be construed as limiting product notification server 200 to specific numbers, types, or arrangements of modules and/or components thereof. A person skilled in the art will recognize many variations, alternatives, and modifications of embodiments of the present disclosure.

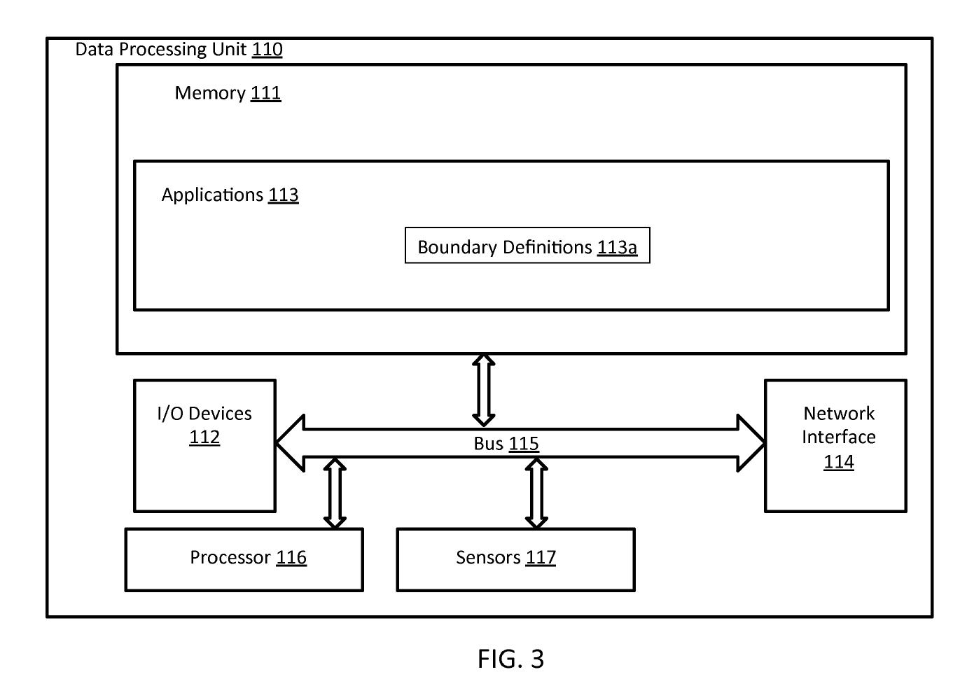

FIG. 3 is a schematic illustration of various components of a data processing unit 110, in accordance with an example system of the present disclosure. However, the data processing unit of FIG. 3 may be similarly representative of an example of a data processing unit 120. Data processing unit 110 includes, but is not limited to, a data memory 111 with one or more installed applications 113, a computing hardware such as a processor 116, Input/Output (I/O) devices 112, a network interface 114, a configuration of sensors 117, and a system bus 115 that operatively couples various components including data memory 111, processor 116, I/O devices 112, network interface 114, and sensors 117. I/O devices 112 may include a display screen for presenting graphical images to a user including images associated with one or more notifications and/or protective alerts.

Data processing unit 110 also includes a power source for supplying electrical power to the various components thereof. The power source may, for example, include a rechargeable battery.

Memory 111 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a stylus.

Additionally or alternatively, I/O devices 112 include a mouse or a joystick operable to receive inputs corresponding to clicking, pointing, and/or moving a pointer object on the graphical user interface. I/O devices 112 may also include a keyboard operable to receive inputs corresponding to pushing certain buttons on the keyboard.

Additionally, I/O devices 112 may also include a microphone for receiving an audio input from the user, and a speaker for providing an audio output to the user.

Applications 113 may include but are not limited to one or more programs configured to facilitate provision of a relevant content delivery service to consumers carrying data processing units 110. In an embodiment, an application 113a may be configured to define the virtual boundaries of geo-fenced locations, for example, in terms of distance from one or more cell phone towers as derived from transmission signal strength or in terms of GPS location on the Earth's surface and may be correlated with a street address.

Moreover, sensors 117 may include one or more of: an accelerometer, a magnetometer, a pressure sensor, a temperature sensor, a gyroscopic sensor, a Global Positioning System (GPS) sensor, or a timer. Sensors 117 may be used to measure and collect data related to surroundings of the user including, for example, position information from one or more satellites or communication towers and/or position information broadcast by beacon-emitting hardware.

In some examples, a product notification management application may be interfaced with sensors 117. When executed on processor 116, the product notification management application is configured to resolve and integrate outputs of sensors 270 into useful information so as to provide the user with notifications and/or alerts.

Moreover, network interface 114 optionally allows data processing unit 110 to communicate with other computing devices such as product notification server 200, for example, via communication network 150.

Data processing unit 110 is optionally implemented by way of at least one of: a mobile phone, a smart telephone, an MID, a tablet computer, a UMPC, a phablet computer, a PDA, a web pad, a PC, a handheld PC, a laptop computer, a desktop computer, an NAS device, a microprocessor, a large-sized touch screen with an embedded PC, and an interactive entertainment device, such as a game console, a TV set and an STB.

FIG. 3 is merely an example embodiment, which should not unduly limit the scope of the claims herein. It is to be understood that the specific designation for data processing unit 110 is provided as an example and is not to be construed as limiting data processing unit 110 to specific numbers, types, or arrangements of modules and/or components thereof A person skilled in the art will recognize many variations, alternatives, and modifications of embodiments of the present disclosure.

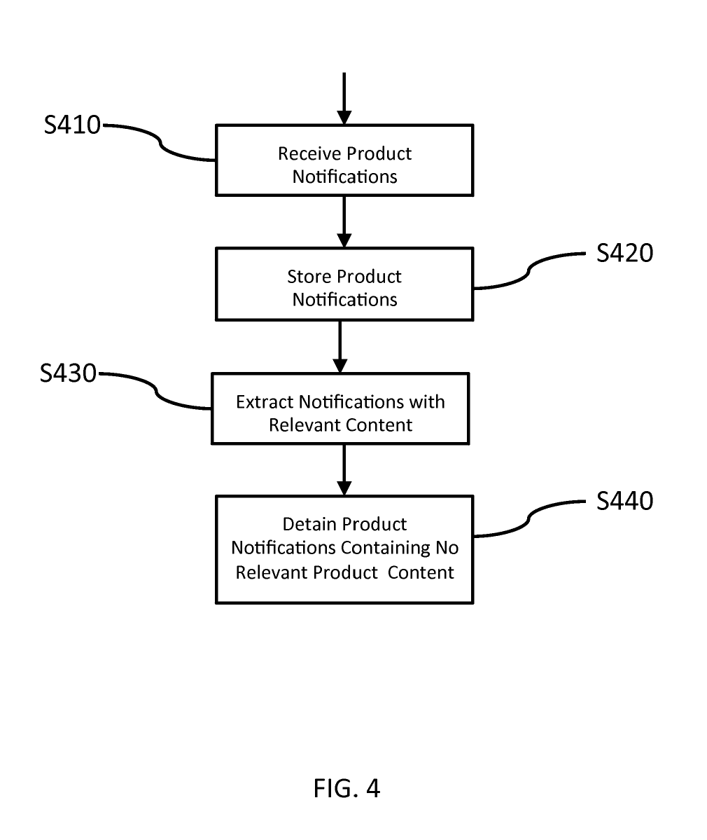

FIG. 4 is an overview flow diagram of an example method for providing a mobile device (such as, for example, data processing unit 110) with relevant content about products. At S410, several product notifications are received. Product notifications may be received by server 200 in any of a variety of manners including by passive receipt from a sender or through active data mining or network crawling, for example, by one or more of sensors 270. Each product notification cites, contains or references a product identifier. The product identifier may be string of characters, a bar code, a QR code or similar which is uniquely assigned to each product. For example a product notification addressing a baby food recall includes a product number uniquely identifying the product being recalled.

Once several product notifications have been received, at S420 the several product notifications are stored in product notification database 140 for future content relevancy determinations. Production notifications stored in database 140 may be periodically deleted as they expire or are replaced but more recent notifications. At S430, from the several product notifications, one or more product notifications containing relevant product content are extracted. As will be described in greater detail below, relevant product content is that belonging to a given business class provided in accordance with a mobile device location. At S440, the several stored product notifications not extracted are detained from the mobile device and maintained at the product notification database for possible future extraction.

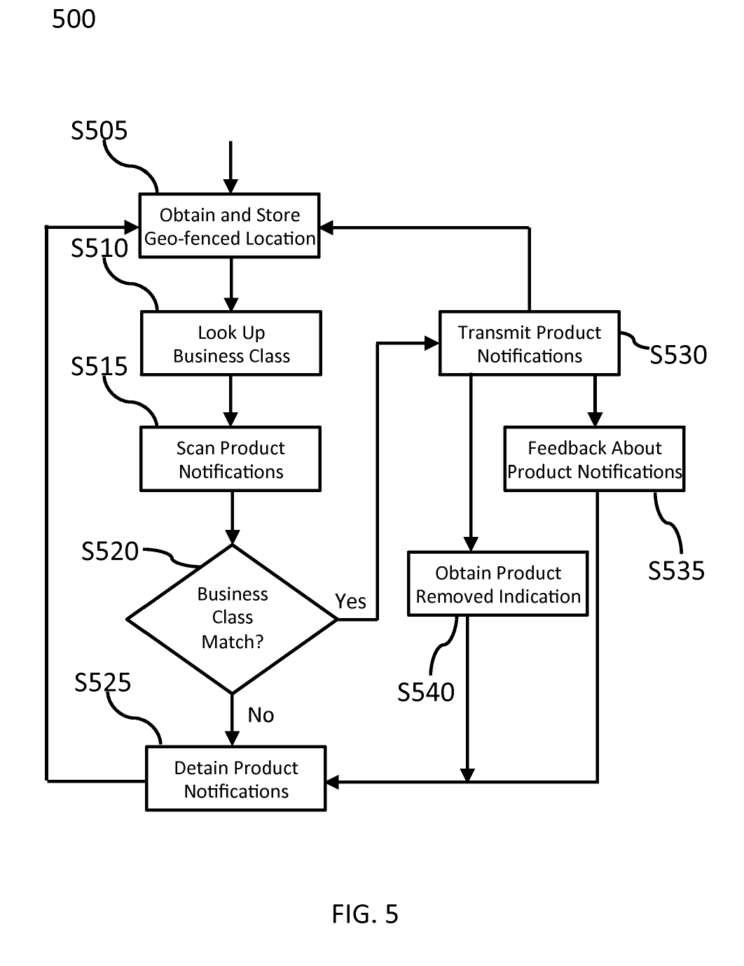

FIG. 5 is a flow diagram of an example process for extracting notifications with relevant content. With several product notifications stored in product notification database 140 as described above, at S505, a geo-fenced location is obtained from a consumer mobile device and stored (at 140). The geo-fenced location may be a region within a virtual boundary defined on a geographic area in accordance with rules programmed into mobile device 110. Mobile device 110 receives position information and records a geo-fence entry timestamp when the received position matches the region bounded by the geo-fence. This entry timestamp may then be transmitted from mobile device 120 to server 200.

The scale of the geo-fence may vary. In some embodiments, beacon-emitting hardware may be installed and activated at a position in the geo-fenced location so as to broadcast position coordinates to all listening mobile devices within a pre-defined radius. Mobile devices receive a unique identifier usable to determine proximity of the mobile devices to the beacon-emitting hardware. With this technology, a mobile device can establish itself in the immediate proximity of the beacon hardware (on the order of inches), near to the hardware (on the order of meters), or far from the hardware (more than 10 meters).

At S510, a business class for the obtained geo-fenced location is looked up in a registry. At a step S515, the several product notifications stored in database 140 are scanned for product identifiers matching the business class of the geo-fenced location in order to determine, at S520, whether product notifications match the business class.

At S525, one or more product notifications not containing product content matching the business class are detained as containing no relevant product content. For example, if the mobile device enters a geo-fenced location associated with a hardware store business class, the mobile device user is not in danger of purchasing a contaminated prescription drug. Thus, the consumer need not be alerted about a recall of a ribavirin product. Therefore, a product notification regarding this product will be detained or withheld from the mobile device user; in other words, the notification is not provided to the mobile device of the user by the server system. The product notification will continue to be detained as long as the consumer mobile device does not transmit a geo-fenced location entry timestamp consistent with a pharmacy business class.

At S530 product notifications with relevant content are transmitted to the mobile device. Again taking the example of a consumer entering a geo-fence location associated with a hardware store business class, without being fully informed, the mobile device user may be inclined to purchase a snow blower that has been recalled due to a leaky carburetor bowl nut. Since the consumer mobile device is present in a hardware store, a product notification regarding this snow blower will be transmitted to the mobile device upon receipt of the geo-fence location entry timestamp associated with a hardware store business class.

A consumer mobile device may receive any number of product notifications. While only a single product notification addressing a single product is transmitted in the above example, it should be noted that the number of notifications transmitted is only limited by the number of product notifications relevant for a given geo-fenced location and/or by various input/feedback from the mobile device user and an administrator of the business established at the geo-fenced location. In one instance the mobile device may receive two product notifications upon passing through a geo-fence boundary while receiving twenty in another instance.

The mobile device user does not need to reveal anything about himself or herself in order to take advantage of product notification delivery since any mobile device registered for a relevant content extraction service receives the relevant product notifications upon arriving at the geo-fenced location without any consumer identifying information.

Having registered for the service and initialized a consumer profile, with the client application running on his or her mobile device 120, a consumer may modify his or her consumer profile with descriptive information to influence product notifications received. With this voluntary information, future alerts to the consumer may be customized for that consumer so that unrelated or overly broad alerts may be avoided in the future.

FIG. 5 additionally illustrates a process by which a consumer influences interpretation of relevant content with consumer feedback. Having received a product alert transmitted at S530, a consumer may choose to provide feedback to product notification server 200 in order to change the types of product alerts received at the mobile device in the future. For example, the consumer may input information about products he or she owns such as an identification number, brand, model, and/or year of a vehicle. The feedback is received from the mobile device at S535, indicating one or more product notifications are not applicable to the mobile device or the consumer thereof. Returning to S525, product notifications tagged with consumer feedback are detained in future transmissions.

In an example application of consumer feedback, a consumer may elect to modify his or her consumer profile to specify medications regularly taken. With this information associated to the consumer's profile, only product notifications addressing medications or brands the consumer commonly uses are transmitted. This reduces the number of medications or brands the consumer would otherwise be alerted about. Further, if a consumer's profile has been modified to include current medications taken, upon entry into a restaurant or grocery store, the consumer may be alerted to products known to harmfully interact with one or more of these medications.

In another example, a consumer may modify their profile with known allergies. Upon entry into a restaurant or grocery store, they may be alerted by product notifications indicating products available at the restaurant or grocery store have the potential to cause allergic reactions.

In yet another example, if a consumer enters a pharmacy or hospital to pick up their prescription or receive a medical procedure they may be alerted to any prescriptions or products on recall or any medications with potential counterfeit problems.

Because all product notifications potentially offered at a given class of business are transmitted to the consumer by default, a product appearing on a consumer's notifications list when the consumer enters the geo-fenced location may not necessarily be on offer from a business of the geo-fenced location. Since a consumer who has registered for the service to receive alerts related to recalls or other safety notices may be deterred from a given business established at a geo-fenced location if they receive a large number of alerts upon entry, motivation exists for the business to minimize any list of alerts the consumer may receive. Businesses participate in the service keeping consumers safe by registering and logging on to update a list of products they offer for sale.

Businesses are able to establish their own business profiles to allow them to update inventory to address products they do not sell, service, repair or manufacture. If a business has registered a business profile for the service and has excluded a product from the list of products the business offers, product notifications regarding the product will no longer be transmitted. For example, a business formerly offered a product XYZ but, for any of a number of reasons, no longer sells the product. To prevent product XYZ from appearing in consumer alerts when consumers enter the geo-fenced location of the business, the business can remove product XYZ from a list of potential products associated with the business through location identifier within the database.

At S540, a product removed indication is obtained from an administrator terminal of the business established at the geo-fenced location. The product removed indication may include product identifiers of one or more removed products. Returning to S525, any product notifications citing product identifiers matching the one or more removed product identifiers are detained.

In an example, an application programming interface synchronizes products between a business master database and the product notification database to eliminate any negative impact to business image. Thus, removal of a product from the business master database causes a dissociation of the business and/or business location from that product in the product notification database.

Over time, presently disclosed systems, may amass a database of product inventory enabling contribution of a key attribute to analytic engines to, for example, assist brands with market penetration and demographics determinations. From these results the businesses may monitor the effectiveness of their current advertising and or promotions in real-time while consumer data remains anonymous at all times under consumer-defined permissions and roles.

In some embodiments, an administrator of a business may log onto the system and select, for removal from visibility when consumer mobile devices enter the geo-fence designated area, products removed. Additionally or alternatively, selection of product notifications concerning these products removes from inclusion in transmissions to the consumer mobile device, the associated product notifications.

The system is not limited to allowing modification to consumer profiles to alert consumers about medications or allergens. For example, consumer profile settings enable the consumer to indicate food preferences such as sustainable foods, organic foods, care-free foods, hormone-free foods, non-gmo foods, dairy free foods, wheat free foods, grass fed foods, farm-raised foods, vegetarian foods, vegan foods or any combination of these. The present systems may also enable a consumer to modify their profile by identifying their family members.

Sustainability certification of a business can be maintained through a track and trace system. For example, if a seafood restaurant has become a member of a sustainability certification program such as those established by the Marine Stewardship Council, management of the restaurant will need to demonstrate that the seafood was fished by a fishery that: does not over-fish or deplete exploited fish populations or that can demonstrate fishing in a way that leads to recovery of these populations; allows for maintenance of the ecosystem on which the fishery depends; and respects local, national and international laws and standards. The restaurant will also need to demonstrate that the seafood is identifiable, is segregated from non-certified products, is traceable in accordance with volume and that the restaurant has a management system. When a mobile device consumer enters the restaurant, he or she will be alerted to the enrollment of the restaurant in the sustainable certification program and the restaurant's compliance with the program. For example, the consumer mobile device may be presented with a sustainability score based upon one or more sustainability audits for the restaurant and the chain of custody of the seafood served.

If an e-coli outbreak is associated with spinach, when a consumer enters a geo-fenced restaurant location which normally serves spinach, the consumer is notified in accordance with the present services that potentially contaminated spinach may be in the inventory of the restaurant. Alternatively, if the origin of the spinach is known and the spinach has been tracked, the consumer would only be notified if her or she entered the geo-fence of a restaurant known to have received the potentially tainted spinach.

Embodiments of the systems disclosed herein enable restaurants or their food distributors to select, from a master database, products purchased by the restaurants for inclusion in menu items. The master database is arranged to allow the restaurant chef or owner to expand their master database to define the ingredients in their menu items. For example, a restaurant owner may construct a menu item profile for one or more menu items which profile specifies ingredient products in each menu item. With the menu item profile established, product notifications pertaining to ingredient products will be transmitted to consumer mobile devices upon entry of the device into the restaurant geo-fence. As such, constructing menu item profiles is another manner in which a restaurant owner can arrange for irrelevant product notifications to be withheld from their patrons and improve the image of their business. Meanwhile, the restaurant owner is able to preserve the privacy of any trade secrets associate with menu items since the ingredients are not revealed to consumers—the present services monitor ingredients in menu items and alerts the consumer only to menu items containing allergenic, contaminated or unsustainable ingredients.

It should be noted that the method of FIG. 5 is not only repeatable for a single registered consumer but also repeatable for a number of registered consumers. Furthermore, the service also continuously or nearly continuously receives product notifications for potential transmission to consumer mobile devices.

Businesses established at geo-fenced locations also benefit from the ability to see trends in their customers based on the consumer profiles. The disclosed services not only protect the safety of consumers but also, for example, help restaurants improve their success in establishing a menu that meets the demands of its patrons. The analytics available from consumer profiles provides transparency to restaurant operators that would otherwise be unattainable without conducting a time-consuming survey. Without receiving any private, identifying information from consumers, the business establishment may receive information about the preferences of the consumers who have entered the establishment.

For example, when consumers receive an alert regarding the presence of a food containing an allergen, this consumer's preference can be forwarded to an administrator of the business establishment either singularly or as part of a report containing preferences of a number of consumers who have visited the business. Reports may be forwarded on demand, periodically or randomly from time to time. With these reports, a restaurant manager, for example, may find that a majority of their diners are gluten free. If only 3% of the dishes in the current menu are gluten free, the restaurant manager may decide to update the menu to include more dishes acceptable to gluten free consumers. According to the present services, the business may also be informed as to the number of customers entering the establishment.

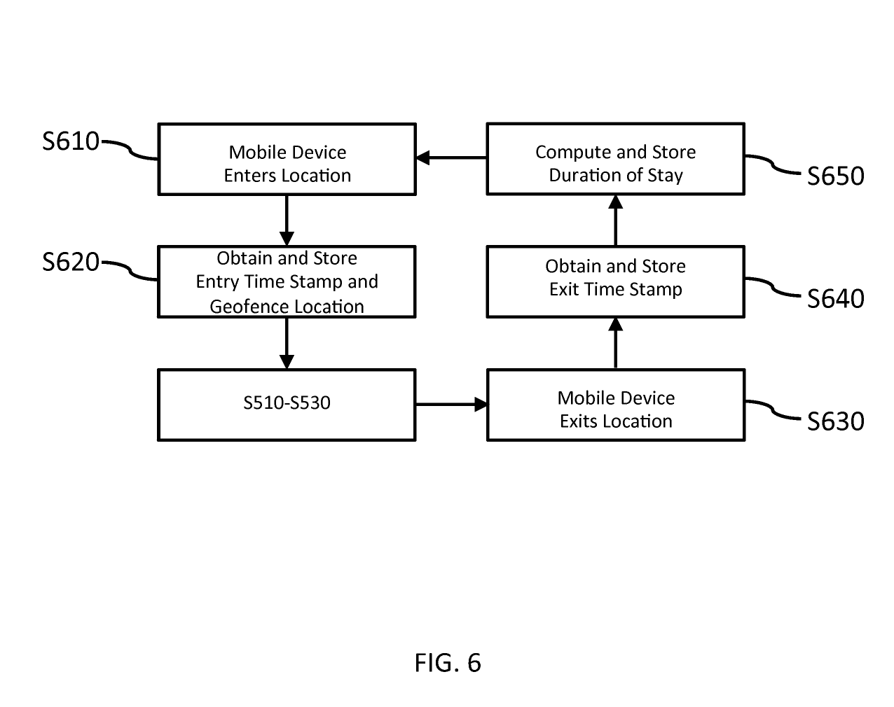

FIG. 6 is a flow diagram of an example process for obtaining a geo-fenced location in accordance with the presently disclosed services. At S610 a mobile device enters a geo-fenced location so that an entry timestamp is received at S620. While present at the geo-fenced location, the consumer mobile device receives one or more product notifications according to the process described with reference to FIG. 5. At S630, the mobile device exits the geo-fenced location and an exit timestamp is received at S640. A duration may then be computed from the entry timestamp and the exit timestamp at S650 and the duration may be stored, for example in product notification database 140.

Accordingly, the business may be informed by the disclosed services as to the length of time consumers were present. For example, a consumer may have entered the geo-fenced location and subsequently shopped for an hour. Alternatively, a consumer may enter the geo-fenced location, receive product notifications and then walk out almost immediately. From this, an administrator of the business established at the geo-fenced location may infer that the consumer was affected by one or more of the received product notifications.

The process of obtaining and storing geo-fenced locations and either transmitting or detaining product notifications based upon their matching a business class of the geo-fenced location is repeated each time the consumer mobile device enters a geo-fenced location. Accumulating geo-fenced location entry timestamps collected over time may be associated with a consumer profile in the product notifications database. The several geo-fenced locations and even the resulting several computed durations may be transmitted to an administrator terminal of one of the geo-fenced locations visited by the consumer at predetermined intervals or upon business administrator request.

With entry and exit timestamps and the computed durations, it is possible for one business establishment to understand the preferences and shopping patterns of consumers who have entered their establishment, as discussed above. The present system may also be configured to correlate consumer activity within one geo-fenced location to activity within another geo-fenced location. This information may be stored and later presented to administrators of businesses established at either of the geo-fenced locations without any need to share any private consumer information. For example, it may simply be recorded that anonymous consumer A visited business 1 and subsequently visited business 2. In a further example, information about the duration of the consumer's stay at either or both businesses may also be stored for later presentation to either or both of the administrators.

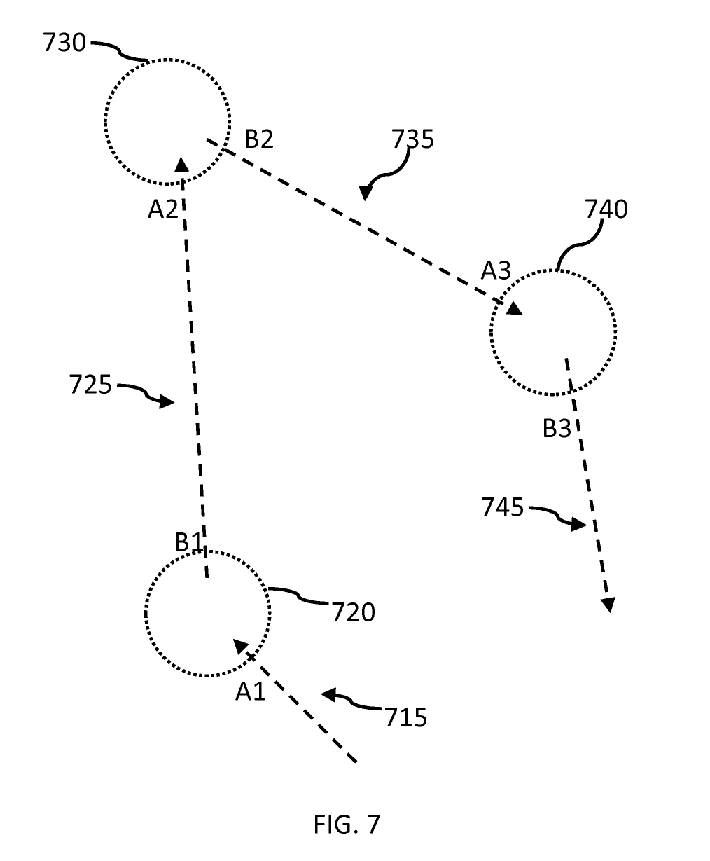

FIG. 7 schematically illustrates an example user path 715, 725, 735 and 745 through a number of geo-fenced business establishments 720, 730 and 740. The user may depart his or her residence and proceed along path 715 and enter establishment 720 generating an entry timestamp A1. Upon departing geo-fenced establishment 720 along path 725, an exit timestamp B1 is generated and stored. From timestamps A1 and B1, the disclosed systems calculate a duration of the user's stay at establishment 720. Continuing, the user enters establishment 730 causing a generation of an entry timestamp A2. After some time, the user departs along path 735 from establishment 730 generating an exit timestamp B2 and enabling calculation of a stay duration at establishment 730. Next, the user arrives at establishment 740 generating an entry timestamp A3. Later, the user departs along path 745 generating an exit timestamp B3 from establishment 740. As such computation of stay duration at establishment 740 is enabled.

It should be noted that the path of the user between geo-fenced establishments need not be known to determine the user's entry and exit time stamps at a given establishment. Furthermore, the trajectory of a consumer's path upon entry or exit does not impact execution of the presently disclosed services. For example, path 735 may not be a straight line between establishment 730 and establishment 740. Nevertheless, it is also possible to construct a general path of the user even if positions between geo-fenced establishments remain unknown.

According to another benefit of the presently disclosed services and systems, a consumer may also receive real-time incentives based on their location within a geo-fence. This may eliminate managing coupons or other incentives that inevitably expire. The real-time digitally delivered incentives allow manufacturers, retailers or both to promote items at national, regional or local level and to create these incentives based on time of day, geo-fenced location or even location within a business established at the geo-fenced location, for example, when the consumer approaches a product display area.

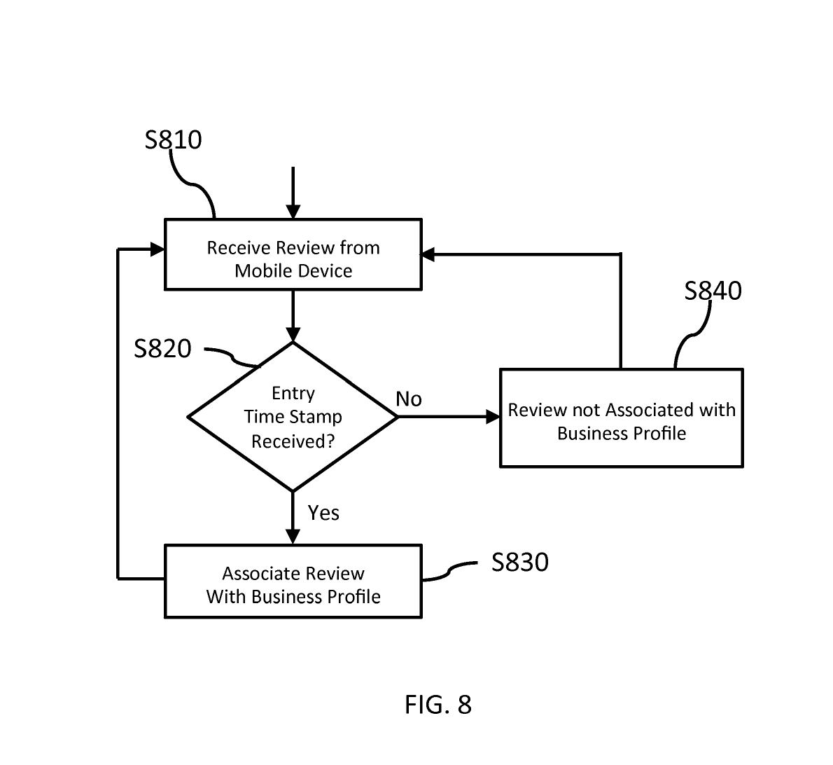

In some embodiments, consumers registered for the service are able to provide reviews of businesses established at geo-fenced locations in order to improve profitability for those businesses. Presently disclosed service offers businesses with validated consumer reviews. FIG. 8 is a flow diagram of an example process for verifying consumer reviews. At S810, a review is received from a consumer's mobile device regarding a business associated with a geo-fenced location in the product notification database. At S820, it is determined whether an entry timestamp has been received from the mobile device for the geo-fenced location identified by the review. At S830, the review is associated with a business profile of the business established at the geo-fenced location when an entry timestamp has been received from the mobile device for the geo-fenced location. At S840, the review is not associated with the business profile when no entry timestamp has been received from the mobile device at the geo-fenced location. This process repeats for subsequent reviews from the same consumer mobile device and for other mobile devices. In addition to declining to associate a consumer review with a geo-fenced location the consumer has not visited, a probation status may be assigned to the consumer profile associated with the mobile device.

In an example, a review received from the mobile device may indicate products reported by the business establishment as removed are actually present at the geo-fenced location. When the system can confirm an entry time stamp from the consumer for the geo-fenced location, a business profile of the geo-fenced location is tagged with the review. Of course, there will also be instances in which a business removes products from inventory and submits a removed product notification to server 200 but no feedback is received from consumers to indicate whether or not product removal can be verified. As such, the process reflected in FIG. 8 has an initial prerequisite of a consumer review.

In an embodiment, when a consumer mobile device enters a geo-fenced business, he or she may receive a social score index for the business in addition to or rather than protective alerts. The social score index is determined from aggregating consumer reviews from a number of top consumer review sites and/or social networking platforms such as, ZAGAT, Angie's List®, Yelp, tripadvisor®, Twitter® and Facebook®. The aggregate social score index may also incorporate reviews provided to the present platform directly from consumers. Such direct reviews, as set forth above, may be validated against geo-fence entry and exit data before inclusion in the social score index. In some embodiments, an aggregate rating number derived from validated direct consumer reviews and reflecting a “watchout score” may be presented to a consumer mobile device in addition to or instead of the social score index. Either or both of the “watchout score” and the social score index may reflect qualities of service, ambiance, food, etc.

The steps of FIGS. 4-8 are only illustrative and other alternatives can also be provided where one or more actions are added, one or more actions are removed, or one or more actions are provided in a different sequence without departing from the scope of the disclosure herein.

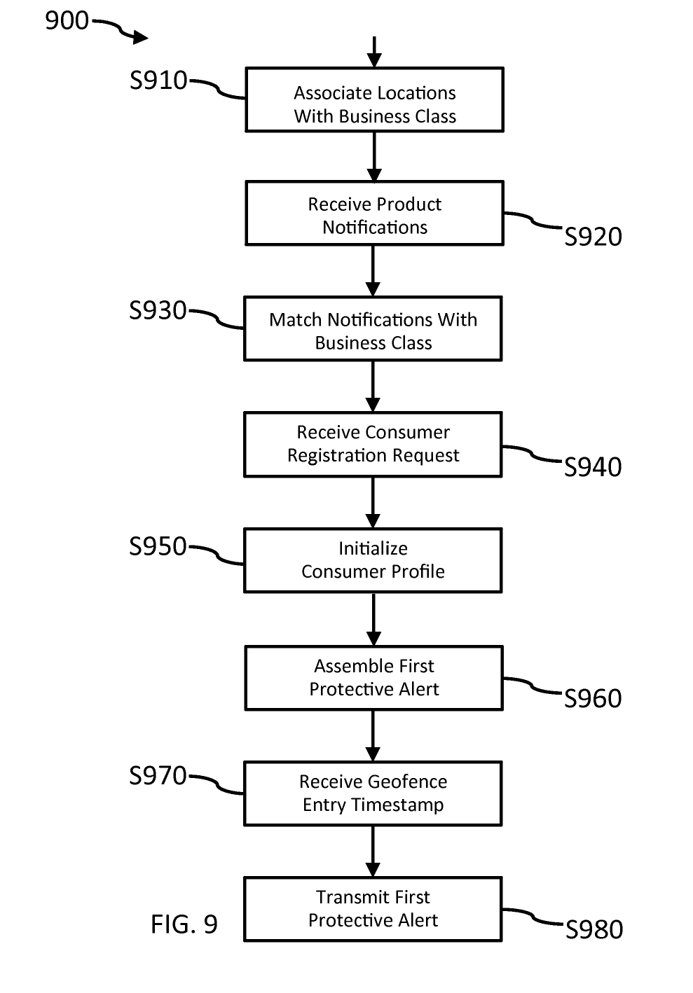

FIG. 9 illustrates a flow diagram of a computer-implemented method for providing a mobile device with relevant product content in accordance with another example service. Within the method of FIG. 9 a consumer profile is initiated and geo-fenced locations and business classes are associated before any geo-fenced location timestamps (entry or exit) are received. This approach may expedite delivery of relevant content product notices to the consumer. At S910, a geo-fenced location is stored in association with at least one business class in a product notification database. At S920, several of product notifications are received. As explained above, receipt of product notifications is an ongoing process.

At S930, each of the several received product notifications are matched with one or more of the at least one business class. It should be noted that any given product may be offered by a variety of business classes and it is likely that any given business class offers a number of products to which product notifications pertain. At S840, a registration request is received from a user of the mobile device which request includes a mobile identifier of the mobile device. In the product notification database, a consumer profile identified by the mobile identifier is initialized at S950. Initialization may include storing the mobile identifier in association with any information the consumer is inclined to provide at registration. For example, the consumer may supply information about allergies to the service by way of the product notification database of a system configured to implement the service.

At S960, a first protective alert is assembled from one or more of the several product notifications matching the at least one business class associated with the geo-fenced location in the product notification database. In the case where a number of products associated with a business class of a geo-fenced location have issues such as recalls or contamination, a number of product notifications will be included with the protective alert. At a step S970, a first entry timestamp referencing the geo-fenced location is received from the mobile device. At a step S980, the first protective alert is transmitted to the mobile device.

Because the present service instantly alerts consumers entering a food service or grocery store geo-fenced location that a potentially contaminated item may be in inventory, the consumer is able to avoid the contaminated item and reduce the spread of potentially harmful bacteria. Producers and/or manufacturers who issued product notifications citing the recall or contamination are also able to push incentives down to a consumer arriving at the geo-fenced location. Additionally, because manufacturers may inform potential consumers through the service, before a product is purchased, the manufacturer's financial exposure may be reduced.

In an example, when a consumer enters a grocery store, an alert is triggered from the client application when the consumer engages the client application within a geo-fenced retail space. The consumer is thereby notified of all products potentially on offer at the grocery store which have been listed as compromised on one or more government lists. The consumer is thereby prevented from buying one or more potentially dangerous products.

In an example, when a consumer enters a tire service center geo-fenced location, the consumer may be presented with brands having current recalls. With this information the consumer may be able to make better decisions more quickly. In another example when a consumer enters a geo-fenced gas station location, they may receive an alert regarding a combination of both food & beverage service and vehicle data.

In yet another example, when a consumer enters a geo-fenced automobile rental facility, product notifications are transmitted to the mobile device of the consumer which cite vehicles that have been reported for recalls.

In a further example, upon entering a restaurant, a consumer may receive a notification informing them of a food borne illness outbreak related to spinach. If the consumer is unable to determine the pedigree of the spinach affected by the contamination he or she may then elect to not order a spinach salad offered on the restaurant menu.

In an enhancement, the systems disclosed may permit restaurants to input and associate one or more of their food source suppliers so that the restaurant may be notified when a product has been recalled. With this information, the chef, cook or waiter can prevent the product from reaching the consumer and can furthermore indicate the product as removed so that product notifications addressing it are not transmitted to visiting consumers.

In another example, if a female student lives alone in college, the system may, based on student's location, use government data to notify the student when a registered sex offender has moved into the area.

Associates and employees of a business established at a geo-fenced location are also informed of the presence of a recalled or contaminated product and can remove the product from the inventory of the geo-fenced location so that the business is not associated with product recalls or contaminations in the mind of the consumer.

In some embodiments, video messages personalized for the consumer may be included with the product notifications transmitted to the consumer's mobile electronic device upon entry through the geo-fence. As examples, the owner/manager of a business could have a personalized video message; a local farmer, rancher or fisherman may be featured in a video describing their sustainability mission or the profile of their business; an executive from a manufacturer may provide a video message regarding a specific recall in order to engage with the consumer to mitigate damage to the manufacturer reputation.

The process of receiving geo-fenced locations and transmitting protective alerts as illustrated by way of example in FIG. 9, is repeated each time any consumer mobile device enters a geo-fenced location or engages with the client application within the geo-fenced location. For example, actions S960-S980, may execute once as a user mobile device enters a first geo-fenced location operated by a first business entity and then execute again as the user mobile device enters a second geo-fenced location operated by a second business entity independent from the first business entity and potentially offering products distinct from those offered by the first business entity. In this way, with the download of only a single client application implemented on a consumer mobile device encompassing all brands, manufacturers, retailers, etc., in accordance with the present systems and processes and executable by one or more components of the presently disclosed systems, key benefits can be provided to the consumer from a variety of independent business entities: product recall information, monetary incentives to purchase food or beverages and/or discounts on items. Multiple applications independently representing different businesses, brands, manufacturers and franchises are not necessary.

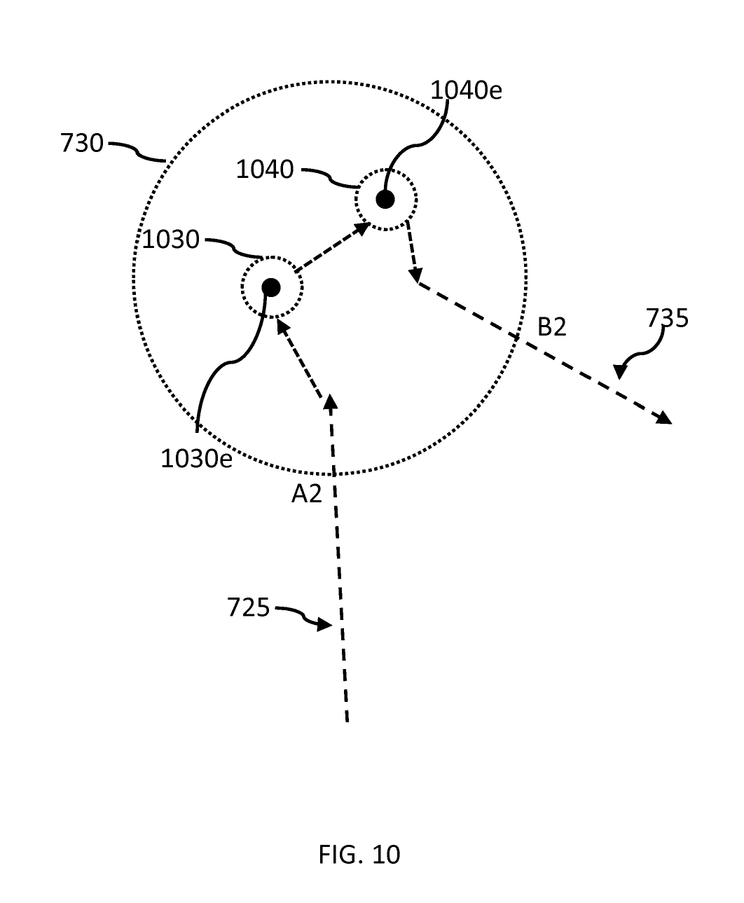

FIG. 10 schematically illustrates an example user path through a number of smaller geo-fenced locations 1030 and 1040 defined within a larger geo-fenced business establishment 730. Locations 1030 and 1040 may be defined as perimeters established by radio frequency signals emitted from beacon-emitting hardware 1030e and 1040e, respectively, installed and activated at a position in the geo-fenced location so as to broadcast position information to all listening mobile devices within a pre-defined radius. One or more beacon-emitting components may be provided within business establishment 730 to define regions encompassing various departments or product displays of the business establishment 730. Thus, when a user mobile device enters location 1030, the user mobile device may receive one or more protective alerts pertaining to one or more products within the location 1030.

As set forth in the above description of FIG. 9, the process of obtaining and storing geo-fenced locations and either transmitting or detaining product notifications repeats each time any registered consumer mobile device enters a geo-fenced location. This includes scenarios in which a user mobile device enters a first geo-fenced location defined by one or more global-positioning satellites or by one or more cellular network transmission towers and subsequently enters a second geo-fenced location contained within the first geo-fenced location and defined by short-range radio frequency signals emitted by one or more beacon components provided within the first geo-fenced location.

Not only consumers but also associates and employees of a geo-fenced business may also receive protective alerts to stay informed of the presence of recalled or contaminated products. This way the associates and employees can remove the products from the inventory so that consumers will not receive protective alerts citing those products and the reputation of the business is not damaged in the mind of the consumer.

In some embodiments, a user with a professional profile, such as a business associate or employee, may be alerted to relevant updates upon entering the geo-fenced business at which he or she is employed. Furthermore, professional users are encouraged to establish a professional profile to receive alerts related specifically to their industry. With a professional profile, the professional user may select brands they are associated with or may select industry-wide coverage to avoid missing any important relevant updates. For example, store clerks, auto dealers, technicians and other roles that may benefit from heightened industry awareness may also take advantage of the present relevant content delivery service.

In an example use scenario, a pharmacist downloads a client application and establishes a business specific profile through which he or she receives protective alerts relevant to the pharmaceutical industry. The pharmacist modifies his or her profile with feedback influencing transmitted protective alerts so as to relate to known medication recalls or counterfeit issues. Thus, he or she is kept up-to-date regarding developments within the pharmaceutical industry so that the necessary actions or precautions may be taken.

A single individual may have both consumer and professional profiles. As with the consumer profile, the professional user profile may provide market data to improve the visibility of brands without compromising user personal information.

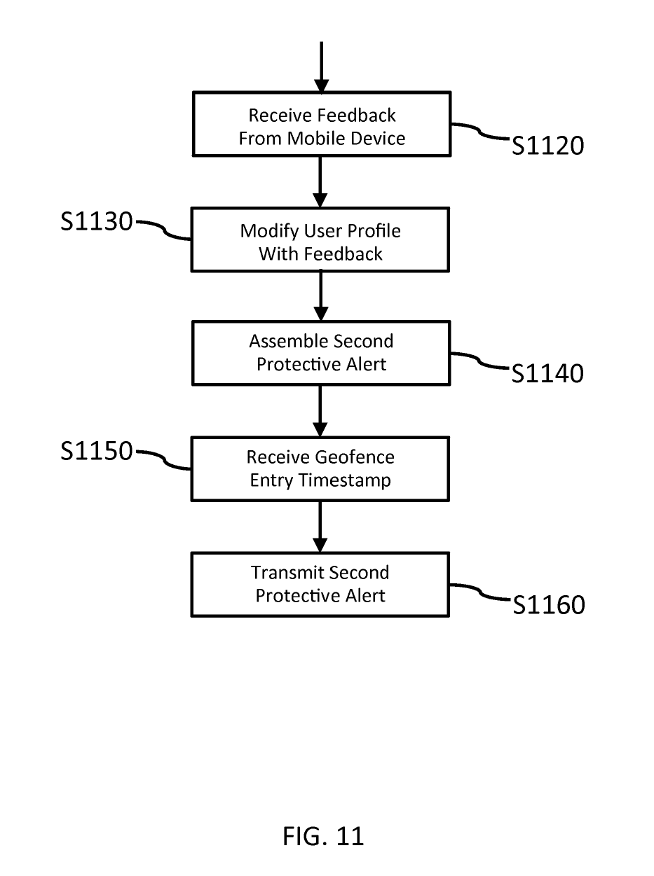

FIG. 11 illustrates a flow diagram of an example process for influencing protective alerts with consumer feedback. At S1120, feedback is received from the mobile device indicating that one or more product notifications of the protective alert are inapplicable to the user of the mobile device. For example, when a protective alert is received, the mobile device user may be able to select individual product notifications for tagging with feedback. At S1130, the consumer profile is modified to reflect the indication of the inapplicable product notifications. At S1140, a second protective alert is created by removing, from the first protective alert, product notifications reflected as inapplicable by the consumer profile. Sometime later, at S1150, a second entry timestamp referencing the geo-fenced location is received from the mobile device. At S1160, the second protective alert is transmitted to the mobile device.

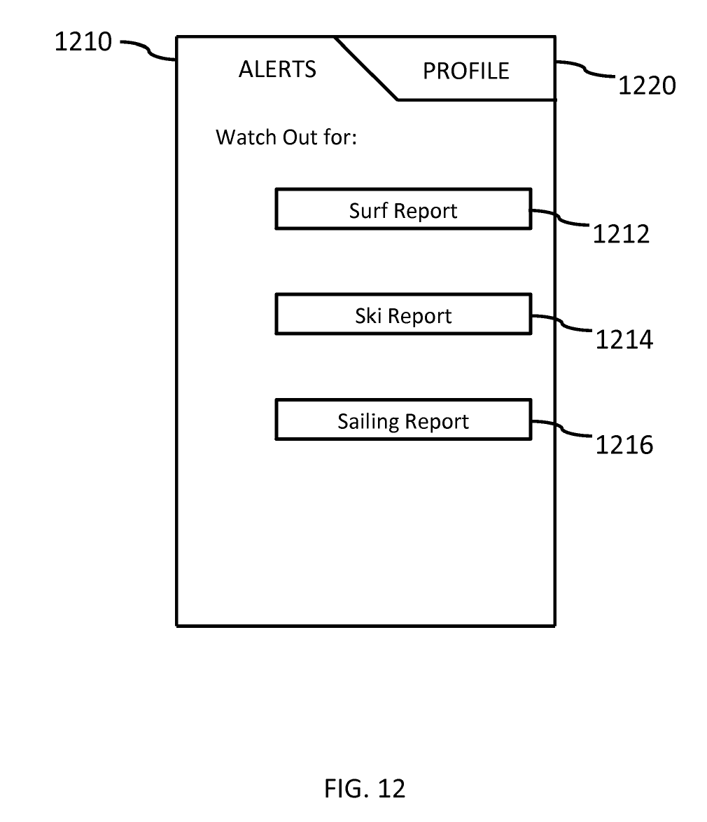

Furthermore, consumers are provided with information that is relevant to their personal lifestyle, health and location. The disclosed systems allow the consumer to provide additional feedback, for example, by customizing their recreational hobbies or activities or activity classes by selecting within the “alerts” tab 1210 (FIG. 12), what he or she would like to watch out for. For example, the consumer may elect to receive a surf report by selecting button 1212, a ski report by selecting button 1214, or a sailing report by selecting button 1216. The systems are capable of alerting users to activity conditions with an activity report reflecting the conditions. For example, a surfer when he or she enters an area where the water has been determined as unhealthy for recreational use and capable of monitoring ski conditions and informing the skier the moment her or she enters a geo-fenced, designated area that skiing conditions are to his or her preference. Additionally, consumers could be informed of specific ski trail hazards or conditions reported by other consumers.

FIG. 12 illustrates an example of a GUI usable with presently disclosed systems for interacting with a relevant content delivery service. A ‘PROFILE’ tab provided for selection by a consumer user presents information and inputs regarding the user's consumer profile. In an expansion of the current service, in addition to recall information, consumers are provided with information that is relevant to their personal lifestyle, health and location. The disclosed systems allow the consumer to provide supplemental feedback, for example, by customizing their recreational hobbies or activities or activity classes by selecting within the ‘ALERTS’ tab 1210, what he or she would like to watch out for. For example, the consumer may elect to receive a surf report by selecting button 1212, a ski report by selecting button 1214, or a sailing report by selecting button 1216. The systems are capable of alerting users to activity conditions with an activity report reflecting the conditions. For example, ski conditions may be monitored and a skier may be informed the moment her or she enters a geo-fenced, designated area that skiing conditions are to his or her preference. Additionally, consumers could be informed of specific ski trail hazards or conditions reported by other consumers.

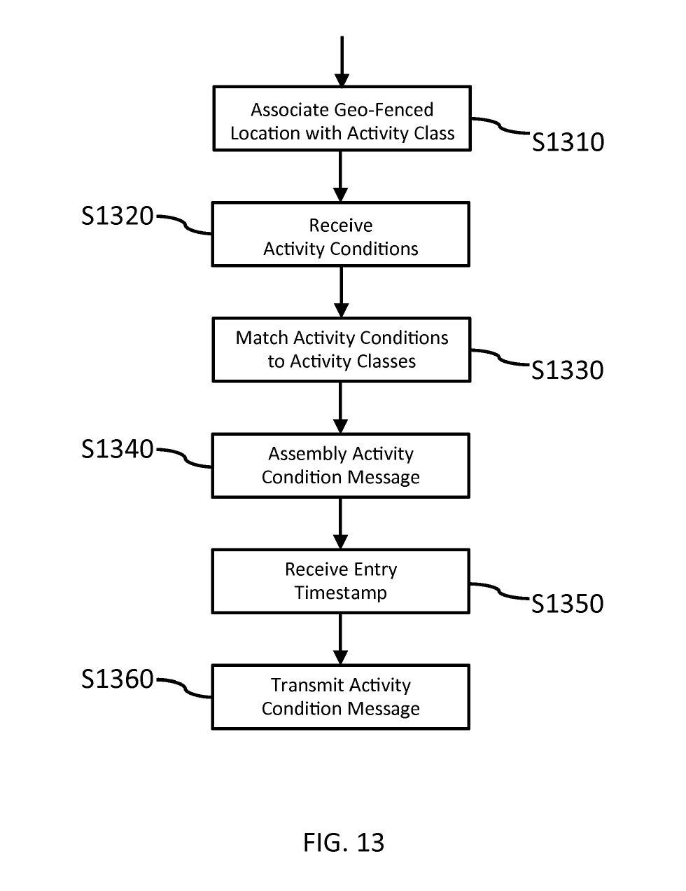

In an example method of providing a user with relevant conditions illustrated in FIG. 13, a geo-fenced location is stored in association with at least one activity class in an activity condition database at S1310. When a number of activity classes are received at S1320, each of the received activity conditions are matched with one or more of the at least one activity class at S1330. A first activity condition report is assembled, at S1340, from one or more of the plurality of activity conditions matching the at least one activity class associated with the geo-fenced location in the activity condition database. In response to receiving, from the mobile device at S1350, a first entry timestamp referencing the geo-fenced location, transmitting a first activity condition report to the mobile device at S1360.

The present systems may also be configured to record consumer mobile device behavior to build a set of consumer characteristics and activity classes such as hobbies and interests as additional feedback into what notifications the consumer receives. In addition to business establishments, events and designated locations such as high schools, colleges, arenas, golf courses, tennis courts, parks and recreational locations can be geo-fenced to establish consumer attendance at events. While the venue and/or the event may not have any relevant product notifications related to health safety, the systems may nevertheless collect entry and exit timestamps to establish information such as activity classes of interest to the user.

In an example, geo-fence boundaries may be provided to highway and interstate exits or major roadway intersections. As a consumer mobile device nears an intersection, a highway exit/on-ramp or an interstate exit/on-ramp, the device may receive a protective alert pertaining to one or more nearby businesses. For example, as a mobile device consumer who has been driving on a highway for 4 hours approaches a highway exit, the consumer mobile device receives a coupon for a 10% discount on food at a restaurant accessible from the highway exit. In some examples, multiple protective alerts may be received. If multiple protective alerts pertain to the same type of business or service, they may be ranked in accordance with distance from the exit or with direct consumer reviews or the above-described social score index.

With geo-fence boundaries established at major intersections or at highway and interstate exits, it is possible to establish an automobile's approximate speed from the duration between an exit time of one major intersection and an entry time of another major intersection.

Scheduling for all sporting events, music events, theatre or expositions such as auto shows and conventions are made available to the public. As with notifications for recalls, incentives and contaminations, schedule data will reside within a database for matching with entry and exit time stamps. For example, Petco Park in San Diego is primarily used for baseball games scheduled for a date and time. When a consumer enters the geo-fence of Petco Park, the date, time and location would be recorded and compared with locations and events scheduled within notification database 140 or within an even database (not illustrated) to establish a characteristic of the consumer. If the consumer entered at 6:14 PM on a Saturday and departed through the geo-fence at a time at least 1 hour later, the systems determine the consumer was likely not merely there to drop someone off to the event.

If the consumer attended a concert within a geo fence area, the type of music may be determined from the performer scheduled to perform there and from this, the age range of the consumer may be established.

In another example, a consumer enters a geo-fenced high school and the duration calculated from the entry and exit timestamps is only 2 minutes at around 8:00 a.m. Monday through Friday. From this data it may be determined that the consumer is a parent or guardian of a high school student. On one or more of the days the consumer has been at the high school, her or she proceeds to enter a geo-fenced grocery store at 8:14 a.m. and exits at 9:15 a.m. The consumer then enters a geo-fenced tennis court at 9:30 a.m. and exits at 11:03 a.m. Analysis of the patterns of the consumer and may determine the consumer is a household decision maker at the grocery store and plays tennis as a hobby.

Systems according to selected embodiments of the current disclosure do not receive geo-fence entry data for every address for the purposes of consistently tracking and monitoring a consumer. The geo-fenced locations of interest are those predetermined to be related to events or activities related to the location such as sports, concerts, or education. Sporting events and concerts offer food services and educational facilities have health safety issues and otherwise use emails to report lockdowns, viral infection or similar. The present systems captures the location identity of only designated areas to determine defining characteristics of the individual without seeking his or her name, address or personal identifying data such as sex, SSN or birth date. Using defining characteristics of the consumer to define the consumer allows for manufacturers, retailers, restaurants and/or service providers to have a direct engagement with a mobile user without invading privacy.

Since events mentioned above typically also have food service exposing the consumer to health safety risks the systems report any potential health risk and at the same time collects data useful to identify certain attributes of the consumer for future marketing purposes.

In an embodiment, a consumer or other user wishing the system to have more accurate information about his or her interests and/or lifestyle uses his or her mobile device to select product providers and/or manufacturers whose products the user prefers or frequently obtains. For example, a display of the user's mobile device may present a number of provider icons and invite the user to select the appropriate provider icons. In some embodiments, the user is offered a deeper level of selection with an invitation to select product icons of those products the user has received. In one example, a user may employ a camera or other imaging device to capture visual information about a product, such as by scanning a portion of the product to make a selection. For example, the user may scan a universal product code. With selections made, product identifiers or product provider identifiers which correspond with the selected product icons or product provider icons, respectively, are recorded in product notification database 140 by server 200.

In some embodiments, a user with a professional profile may be alerted to relevant updates upon entering a geo-fenced location representing his or her place of employment. Such professional alerts may or may not be restricted to the particular geo-fenced location defining their workplace. In this mode, professional users are encouraged to establish a professional profile to receive alerts related specifically to their industry. With a professional profile, the professional user may select brands they are associated with or may select industry-wide coverage to avoid missing any important relevant updates. For example, store clerks, auto dealers, technicians and other roles which may benefit from heightened industry awareness may also take advantage of the present service.

In an example use scenario, a pharmacist downloads a client application and establishes a business specific profile through which he or she receives alerts relevant to the pharmaceutical industry. The pharmacist modifies his or her profile with feedback influencing transmitted product notifications so as to relate to known medication recalls or counterfeit issues. Thus, he or she is kept up-to-date regarding developments within the pharmaceutical industry so that the necessary actions or precautions may be taken.

A single individual may have consumer and professional profiles. As with the consumer profile, the professional user profile may provide market data to improve the visibility of brands without compromising user personal information.

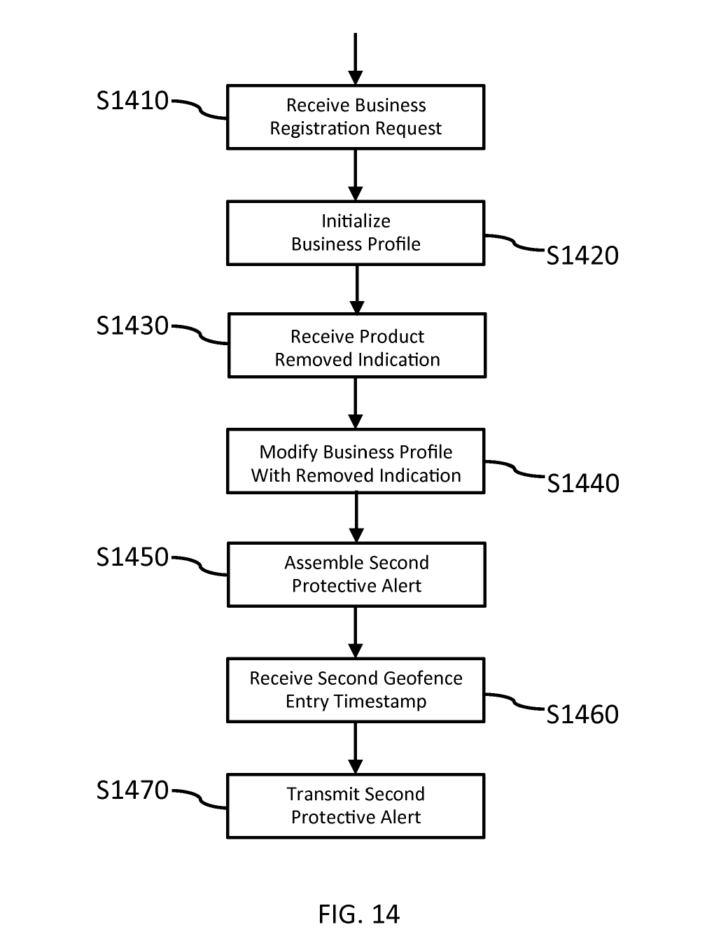

Because all product notifications potentially on offer at a given class of business are transmitted to consumers by default, it may be that some of the products cited in the product notifications have been removed from inventory or were never offered by the local business. FIG. 14 illustrates a flow diagram of an example process for influencing relevant content with feedback from an administrator of a business established at a geo-fenced location in accordance with the present service. At S1410 a registration request is received from a terminal, for example an administrator terminal of the geo-fenced location. The request includes a business identifier which may be an anonymous identifier such as an identifier of the terminal or may be a federal employer identification number. At S1420, a business profile identified by the business identifier is initialized with the first protective alert at product notification database 200. A product removed indication is received from the administrator terminal of the geo-fenced location at S1430. The product removed indication references one or more product notifications of the first alert which identify products not present at the geo-fenced location. In a manner similar to that in which consumer feedback is received, the administrator may simply select for removal one or more product notifications of the protective alert which have been tagged to the business profile. At S1440, the business profile is modified to reflect removal of products identified in the one or more product notifications of the first alert. At S1450, a second protective alert is assembled by removing the one or more product notifications identifying the removed products. At S1460, on a subsequent visit to the geo-fenced location either by the consumer in receipt of the first protective alert or a different consumer, a second entry timestamp referencing the geo-fenced location is received from a mobile device. At S1470, the second protective alert is transmitted to the mobile device.

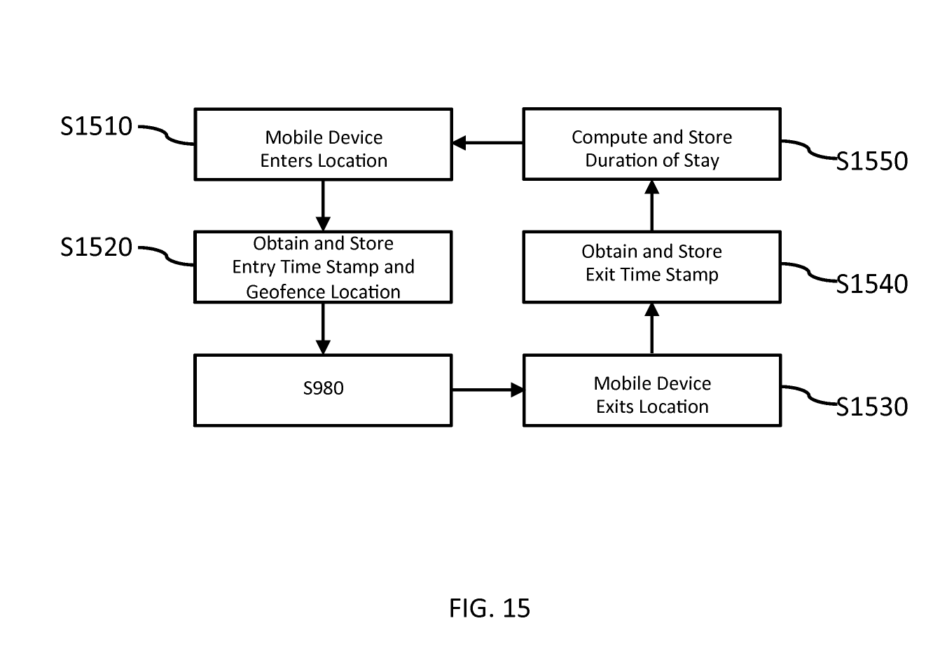

FIG. 15 illustrates a flow diagram of an example process for receiving a geo-fenced location and computing a duration of a consumer's stay in accordance with the present service. The process of FIG. 15 proceeds in a manner similar to that of FIG. 6 except where dependent upon actions represented in FIG. 9. At S1510, the mobile device enters the geo-fenced location. At a step S1520, an entry timestamp referencing the geo-fenced location is received from the mobile device. While the mobile device is present within the perimeter of the geo-fenced location, the first protective alert is transmitted at S980 as described above with reference to FIG. 9. At S1130, the mobile device exits the location sometime after receiving the first protective alert. At S1540, a first exit timestamp referencing the geo-fenced location is received from the mobile device. At S1550, a duration is computed from the first entry timestamp and the first exit timestamp and the duration is stored by modifying the consumer profile to reflect the duration. At any time later, the duration may be transmitted to an administrator terminal of that particular geo-fenced location or an administrator terminal of another geo-fenced location registered for the present service.

Incentive features exist today with mobile applications that are specific to a given company or franchise, for example, major league baseball or a particular airport. In an example, a consumer enters an auto show event and receives an incentive of a 20 oz beverage complimentary to the consumer on behalf of an auto manufacturer displaying at the show. With the download of only a single all-encompassing program product in accordance with the present services and executable by one or more components of the presently disclosed systems, key benefits can be provided to the consumer such as monetary incentive to purchase a food or beverage or discounts on items at a gift store. Multiple applications independently representing different venders or manufacturers are not necessary.

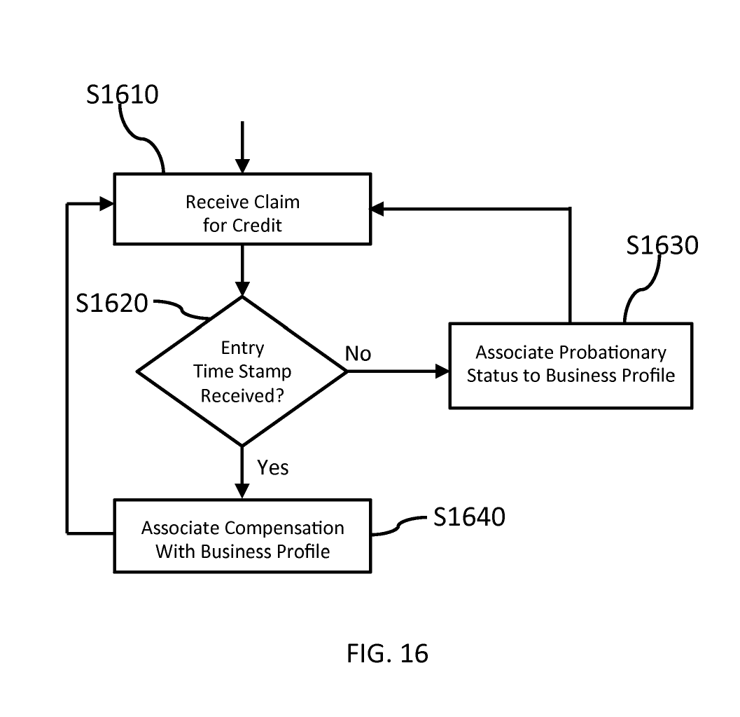

In accordance with the present service, FIG. 16 illustrates a flow diagram of an example process for verifying a consumer claim for manufacturer credit towards a product according to an incentive included with one or more product notifications. Having received an incentive including a manufacturer credit, for example as part of a protective alert, a consumer may choose to purchase the incentivized product using the credit. The credit may be recorded by an associate of the geo-fenced location and the credit may be applied to the consumer's purchase. The credit is being offered from the manufacturer. Therefore, after the transaction making use of the credit, the associate may submit a claim for compensation from the manufacturer in an amount equivalent to the credit. Accordingly, at S1610, a claim for the compensation which cites a mobile identifier of the consumer mobile device is received from an administrator terminal of the geo-fenced location. At S1620, it is determined whether the mobile device identified by the mobile identifier entered the geo-fenced location (i.e., a corresponding entry timestamp has been recorded). When no entry timestamps referencing the geo-fenced location have been received from the mobile device, the business profile is not associated with compensation for honoring the incentive at S1630. In some embodiments, the business profile of the geo-fenced location may additionally be modified to reflect a probationary status. When an entry timestamp referencing the geo-fenced location has been received from the mobile device, the business profile is modified to reflect an association of the compensation with the business profile at S1640. To finalize crediting the business establishment with the compensation, a transfer may be initiated between a deposit account of the manufacturer and a deposit account of the business establishment.

In a security enhancement related to the scenario described above with respect to FIG. 16, the presently disclosed systems and methods may enable payment card issuers to confirm the presence of the user at a place of purchase for each transaction made with the payment card. For example, when a user makes a purchase at their local electronics store with a credit card, the credit card issuer can confirm user presence at the store by verifying at least an entry timestamp for the store's geo-fenced location is associated with the user mobile device in the product notifications database.

As with the method described with reference to FIGS. 4-8, the method described with reference to FIGS. 9-14 also enables validation of consumer reviews of business establishments at the geo-fenced location as described with reference to FIG. 8 above. When a review of the geo-fenced location is received from a mobile device, it is determined whether an entry time stamp has been received for the mobile device at the geo-fenced location. When an entry timestamp referencing the geo-fenced location has been received from the mobile device, the business profile is modified to reflect the review and when no entry timestamps referencing the geo-fenced location have been received from the mobile device, the business profile is not modified to reflect the review and the consumer profile may be modified to reflect a probationary status.

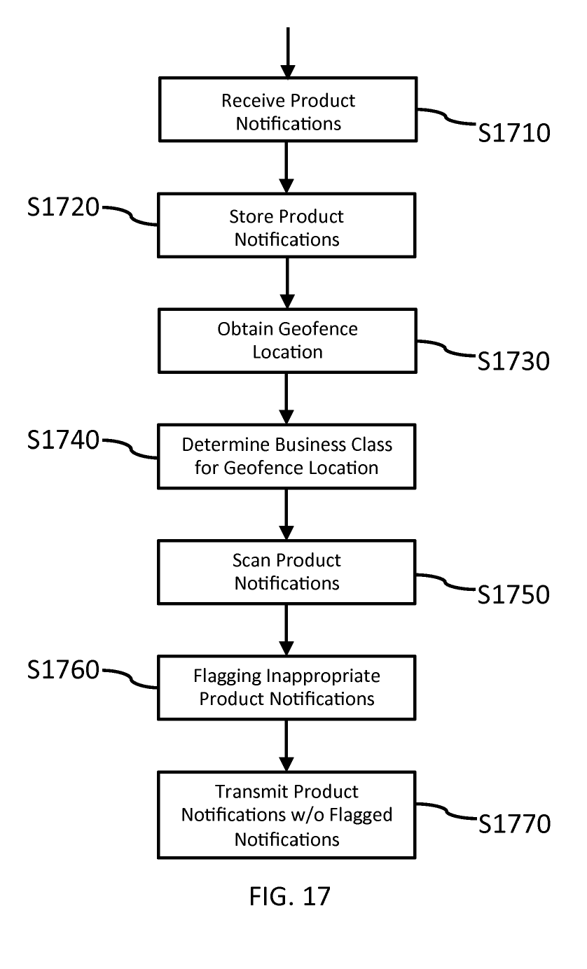

FIG. 17 illustrates a flow diagram of a computer-implemented method for protecting a mobile device from inappropriate product content in accordance with a related service. At S1710, several product notifications are received, wherein one or more of the several product notifications contain the inappropriate product content. As examples, inappropriate product content may include content about products not relevant to a consumer's present location or content about products the consumer does not use or about which the consumer is not interested. At S1720, the several product notifications are stored in a product notification database selectively isolated from the mobile device.

At S1730, a geo-fenced location is obtained from the mobile device upon passage of the mobile device through a geo-fence. At S1740, a business class for the geo-fenced location is determined from a business registry. At S1750, the several product notifications are scanned for product content not matching the business class. At S1760 the one or more product notifications including product content not matching the business class are flagged as containing inappropriate product content. At S1770, the several product notifications are transmitted to the mobile device with the one or more flagged product notifications redacted.

Embodiments of the present disclosure provide a computer program product that includes a non-transitory or non-transient computer-readable storage medium storing computer-executable code for a relevant content delivery service. The code, when executed, is configured to perform actions of the methods of FIGS. 4-17 as described in conjunction with those figures. As actions of the disclosed methods may be provided in different sequences, so the computer-executable code may be configured to provide a service having a different sequence of actions from those illustrated in FIGS. 4-17. In some examples, the code may be downloaded from an application store, for example, from an “App store”, to a data processing unit such as 110 and/or 120.

The present service is configured for delivering topical alerts concerning any brand, retailer, manufacturer, business or business class, may be desirable. If a consumer enters a gas station or independent repair facility then an alert may include all vehicles recently reported with recalls. However, in certain circumstances, the alert a consumer receives upon entering a geo-fence location may be limited to a single specific brand, retailer, manufacturer, business or business class, if appropriate. For example, if a consumer enters a brand A automobile dealership geofence space, only Brand A recalls or incentives are included in the alert.

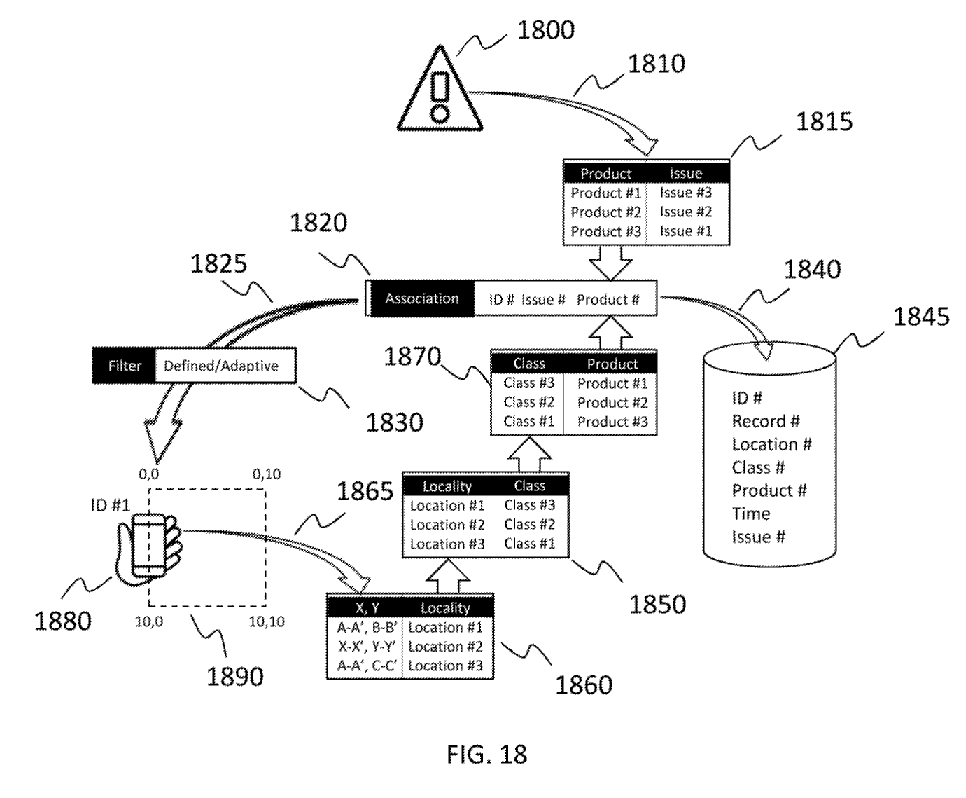

In reference to FIG. 18, the following example demonstrates an embodiment in which services and systems in accordance with the present disclosure are employed. Product warnings and allergen information are stored by one or more organizations in central data repositories 1800 as issues are discovered. Information sourced will often be from authoritative aggregators of relative information such as the Consumer Product Safety Commission, Food and Drug Administration, etc. These issues are in this embodiment are related to products and often limited by lot number, manufacturing date, production facility, date, source, handling, transportation or other specificities. Fetching of this information from one or more sources via a communication network often will require translating information from a source format 1810 to a uniform index format of products with associated issues and actions required 1815. For example, a central data repository 1800 may provide data in Extensible Markup Language (XML) format, which is translated into a plurality of records, whose products and issues are indexed. The indexed data is stored in a computer memory array, database, or other similar indexed data structures, as discussed in more detail below.

As a mobile device 1880 with a unique identification, in this case ID#1, enters a physical boundary 1890 defined by a one or more points or the Euclidian distance between two or more points in Geodetic, Cartesian or Polar coordinates, the location of the mobile device 1880 is transmitted based on a predefined set of parameters which can include time, motion, location, service set identifiers or Universally Unique Identifiers 1865. The location of the mobile device, when sent, is indexed or related to one or more specific location identifiers 1860, which can in some circumstances be a subset of a larger hierarchical set of associated locations (not shown). Likewise, it is nonetheless possible that a particular location of the mobile device may not index against or relate to any specific location identifier.

Determination of the location within the larger hierarchical set allows for classification of the location based on the location and any combination of type, status, inventory, stock, shipments, location feedback or device message 1850. This classification can be based on a range of applicable methods ranging from simple parametrics to adaptive filtering of data related to the location over time. Classification of information 1870 related to the determined location results in the probability of the certain products being present at the previously determined location 1890.

For example, a location identifier of a first grocery store may be a subset of a location identifier of all grocery stores as well as a subset of a location identifier for the shopping center in which the first grocery store is located, grocery stores of that chain, and food stores in that region. Furthermore, the location identifier, and its parent location identifiers are related to one or more classes, such as classes identifying vegetable foods, meat foods, cosmetic products, alcoholic beverages, and over the counter drugs. Furthermore, each class may be related to one or more products, such as the vegetable foods class is related to vegetable products like lettuce, spinach, and kale. In certain embodiments, the classes and/or products are separated, distinguished, or associated through subclasses or other references to manufacturers or distributers to enable the ability to distinguish between similar products from different manufacturers and distributors.

Association of information 1820 presented in a predetermined format 1815 with like information presented in a predetermined format 1870 allows for the storage of information in a predetermined format 1840 relevant to the association which may include ID, Record, Location, Class, Product, Time or Issue and transmit 1845. Association of information 1820 also provides for communication of the immediately relevant information 1825 for presentation on a mobile device 1880. The communication of the immediately relevant information is filtered 1830 based on predefined parameters such as direct user input as well as by parameters learned over time such as don't allow the mobile device to alert for 10 seconds to 2 minutes after ingress into a given location. Adaptive filters 1830 can also utilize historical information from previous communications as parametrizes for data sieving.

By way of example, central data repository has data corresponding to a spinach product that may be tainted with harmful bacteria. The spinach product was grown by Farmer A, and distributed by Distributer B. This data is provided in XML format and translated into appropriate issues and actions by a server system. To assist in the efficient access of data, the product associated with the issue is flagged (in other words, marked or separately indexed) along with its associated classes (such as classes related to spinach, Farmer A, and Distributor B).

Continuing with the example, a user has a mobile device. The mobile device has downloaded sufficient data to indicate a geo-fenced location defining the area of a Grocery Store A. The user with the mobile device enters the Grocery Store. The mobile device obtains its current geographic position, and determines that it is within the geo-fenced location defining the area of the grocery store, and transmits its unique identifier, the location identifier of the grocery store, and its current timestamp to a server system. The server system uses the location identifier to identify classes of products associated with that identifier. Given the large number of potential products, this may return a very large data set. However, this data set can be reduced when it is cross-referenced with current classes that have products with active notifications. As such, the server system identifies a class that is associated with the provided location identifier as well as spinach.

In one permutation of this example, the system, having identified a notification, provides the notification to the mobile device that sent the location identifier. In another permutation, the user has previously provided a preference or setting that the user does not eat vegetables. Accordingly, while the notification matches the location identifier provided by the mobile device, it is withheld (or not provided) because of the prior user preference to withhold such notices.

In another permutation of this example, the mobile device transmits its unique identifier and location identifier to the server system upon a determination that it has entered a geo-fenced location; however, the mobile device does not transmit a timestamp. Instead, the server uses its own current timestamp to mark the entry into the geo-fenced location. Such a methodology is appropriate where the transmission of the unique identifier and location identifier occurs at the time of entry into the geo-fenced location or shortly thereafter. In certain embodiments, the transmission should occur within five minutes of entry; in other certain embodiments, the transmission should occur within sixty seconds; in yet other certain embodiments, the transmission should occur within fifteen minutes.

Feedback from mobile devices can include updates or modifications to parameters established by a user of a mobile device. Parameter sets can be modified over time based on feedback from a user of a mobile device as well as feedback from other users of mobile devices with like or correlated parameter sets. As parameters sets are adaptive they function as weights where a higher weight of a parameter tells the systems that it is more important than other parameters. The system uses these weights to predict the likeness or correlation amongst mobile device parameter sets. An illustrative but simplistic example of this can be seen in the case where we consider parameters for nut allergies, coffee preference along with business subclass linked to daily locations. The parameters can be processed as layers of separate linear regressions to find correlations where in this example people with a preference for coffee in a given set of stores have provided feedback of an allergic reaction where a weighting of coffee preference being amongst the class of locations concluding that there are allergens associated with the coffee stations of a given subclass of store locations.

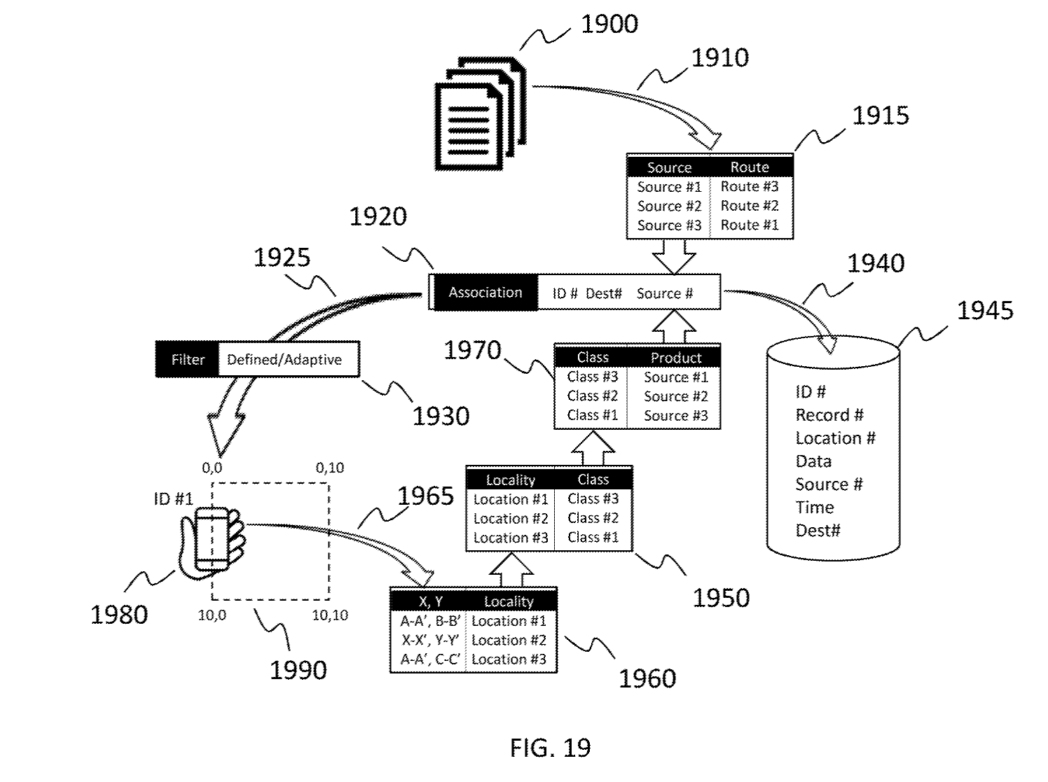

In reference to FIG. 19, the following example demonstrates an embodiment in which alternate services and systems in accordance with the present disclosure are employed. Information 1900, sent from a location is appended with source location and routing metadata along its transmission path 1910 to the predefined location. When data is received at the predefined location the information source location is verified based on the source location and routing metadata gathered from the source location and the routing path which is verified 1915 as a provisional data source.

The provisional data source is associated with an Identification indicated in this example ID#1 1920 which is then filtered based on historical or adaptive filters for parametric control of two part verification using ID#1 1930. The communication 1925 to the device 1980 as a result of association 1920 and filtering 1930 then provides at least its physical location 1990 defined by a one or more points or the Euclidian distance between two or more points in Geodetic, Cartesian or Polar coordinates the location of the mobile device 1980 is transmitted and routing metadata along its transmission path based on a predefined set of parameters which can include time, motion, location, service set identifiers or Universally Unique Identifiers 1965. The position of the verification device, when sent, is indexed to a specific predefined location identifier 1960 which can in some circumstances be a subset of a larger hierarchical set of associated locations (not shown).

Determination of the location within the larger hierarchical set allows for classification of the verification based on the location and routing metadata defining the path class 1950. This classification can be based on a range of applicable methods ranging from simple parametrics to adaptive filtering of data related to the location over time. Classification of location based on origin and routing metadata 1970 related to the determined location results in the probability of the data source being verified in association 1920.

Once information 1900 source is validated the information along with relevant indexing data such as ID#, Record #, Location #, Information, Source #, Time and Dest# can be moved 1940 into storage memory 1945.

By way of example, a system and method is provided for verifying the location of a mobile device. Information source determines that it requires the verification of the location, or in certain instances, a class of locations, of a mobile device of a user. The system communicates relevant source data to a mobile device, which may include data indicating certain geo-fenced locations. The user, with his or her mobile device, enters one of the specified geo-fenced locations or is already within one of the geo-fenced locations. The entry into the geo-fenced location, which includes in this instance the positioning within the geo-fenced area upon receipt of the relevant source data, results in the mobile phone transmitting its location or location identifier along with its unique identifier to the server system. The server system correlates the location data with a class, and the class with the source. Accordingly, the location within a class of locations is verified with respect to the source. In certain embodiments, the source is notified of the location verification of the mobile device of the user.

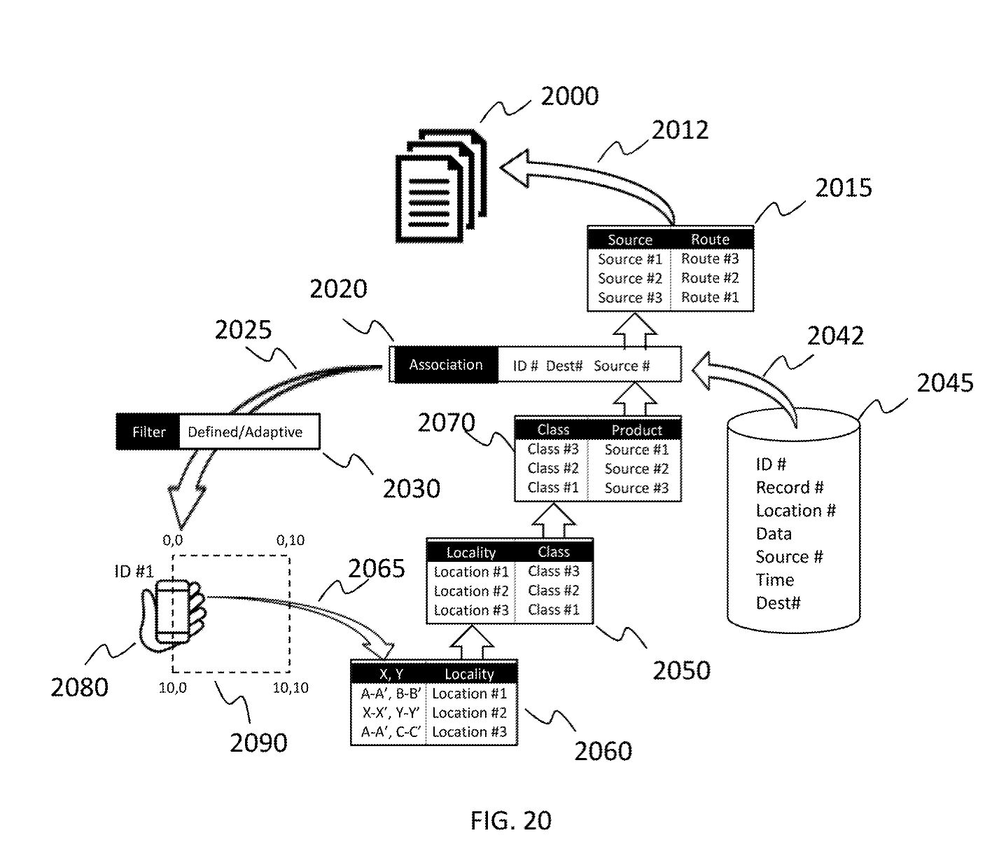

In reference to FIG. 20, the following example demonstrates an embodiment in which alternate services and systems in accordance with the present disclosure are employed. Data from a location 2045, is associated with a provisional destination and routing metadata along its provisional transmission path 2012 to a predefined location. When data is associated with the provisional location, it is verified based on predefined destination location and routing metadata gathered from the destination location and the routing path to be verified 2015.

The provisional data destination associated with an Identification indicated in this example ID#1 2080 is then filtered based on historical or adaptive filters for parametric control of two part verification using ID#1 2030. The communication 2025 to the device 2080 as a result of association 2020 and filtering 2030 provides a notice to the mobile device 2080 requesting at least its physical location 2090. Accordingly, the location defined by a one or more points or the Euclidian distance between two or more points in Geodetic, Cartesian or Polar coordinates the location of the mobile device 2090 is transmitted to the server system, where the transmission includes routing metadata along its transmission path based on a predefined set of parameters which can include time, motion, location, service set identifiers or Universally Unique Identifiers 2065. The position of the verification device, when sent, is indexed to a specific predefined location identifier 2060 which can in some circumstances be a subset of a larger hierarchical set of associated locations (not shown). For example, the location may be a department store, which is a subset of a mall location, which itself is a subset of a shopping district.

Determination of the location within the larger hierarchical set allows for classification of the verification based on the location and routing metadata defining the location class 2050. This classification can be based on a range of applicable methods ranging from simple parametrics to adaptive filtering of data related to the location over time. Classification of location based on origin and routing metadata 2070 related to the determined location results in the probability of the data destination being verified in association 2020 with a particular source.

Once the location of the information is validated, the associated data along with relevant indexing data such as ID#, Record #, Location #, data, Source #, Time and Dest# can be used to convert data previously stored 2045 that has been validated in association 2020. This data is sent via the defined route 2012 determined by a reference associated with the source, where the data provided to the predefined location includes at least the information payload 2000.

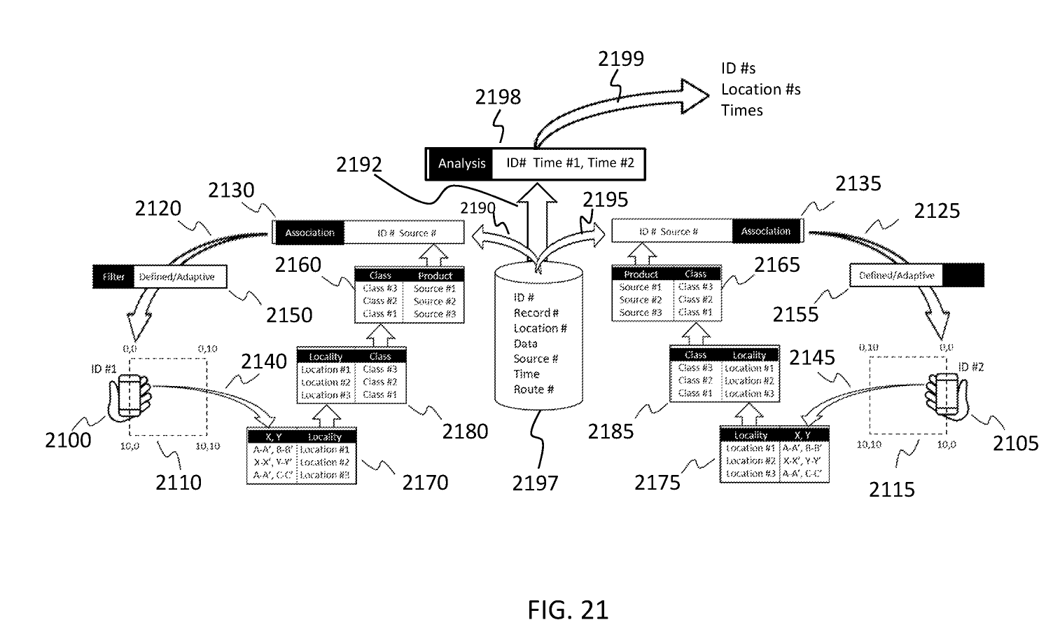

In reference to FIG. 21, the following example demonstrates an embodiment in which services and systems in accordance with the present disclosure are employed. Device identification indicated in this limited example as ID#1 2100 and ID#2 2105 are instructed 2120, 2125 based on historical or adaptive filters 2150, 2155 for parametric control of reporting and local operation of the respective identified device. In other words, the devices 2100 and 2105 are instructed to report on their physical locations, either instantly, prospectively, or retrospectively. The instructional communication 2120, 2125 to the respective devices 2100, 2105 is a result of association 2130, 2135 and filtering 2150, 2155. For example, whether instructions to the particular mobile device are filtered or withheld may be determined based upon prior data gathered by the system, such as location data. The mobile devices 2100 and 2105 then provide at least their respective physical locations 2110, 2115 defined by one or more points or the Euclidian distance between two or more points in Geodetic, Cartesian or Polar coordinates the location of the respective mobile device 2100, 2105. This data is transmitted with routing metadata along its transmission path based on a predefined set of parameters which can include time, motion, location, service set identifiers or Universally Unique Identifiers 2140, 2145. The position of the device, when sent, is indexed to a specific predefined location identifier 2170, 2175 which can in some circumstances be a subset of a larger hierarchical set of associated locations (not shown).

Determination of the location within the larger hierarchical set allows for classification of the location based on location specific parameters and routing metadata defining the path class 2180, 2185. This classification can be based on a range of applicable methods ranging from simple parametrics to adaptive filtering of data related to the location over time. Classification of location based on origin and routing metadata 2170, 2175, related to the determined location results in the probability of the path point being associated with sources 2160, 2165 and subsequently verified in association 2130 and 2135.

Once a path point is validated the associated data along with relevant indexing data such as ID#, Record #, Source #, Time and Dest# can inserted into a data structure of previously stored validated path point's 2197 where the data is stored in a data reduced format structured to use limited processing and memory while maintaining data integrity. Methods of constructing these structures can be based on Device IDs in a common time base resulting in a location indexed data structure, based on Device IDs in a common location base resulting in an indexed time data structure or based on Device IDs in a common location base resulting in an indexed time data structure or on Device IDs in a common intermediate variable resulting in an indexed time and location data structure. Data may be selected 2192 for analysis 2198 to provide relevant identification data 2199 including data sets of IDs, locations, and times.

An application of the current embodiment is to track a disease vector when it presents itself. As a patient enters a medical facility presenting symptoms indicative of a significant public health emergency their unique device, in this case ID#1 2190, can be used with proper authority to retrieve common path points from other devices based on at least location and time indexing. In this example, an authorized user can utilize the device ID#1 with other parameters to determine that this device was in close proximity to device ID#2 for 25 minutes, 14 hours ago. Allowing an authorized user to index the data structure based on significant disease variables including at least the method of transmission and incubation period. This allows anonymous alerts to be sent as needed to indexed devices and as authorized users enter active device ID# for others presenting the disease a disease vector can be determined as well as a virtual cordon sanitaire, quarantine or notification.

Embodiments of the present disclosure are susceptible to being used for various purposes, including, though not limited to, enabling users to obtain notifications about products.

An advantage of selected embodiments of the systems and methods disclosed herein includes the separation of determination of boundary transgression to the mobile device. Instead of blindly transmitting the mobile devices location to the server system, the mobile device has some prior information of relevant boundaries and only notifies the server system upon entry into or exit from the particular location. The notification to the server system may include GPS coordinates of the current location of the mobile device, or it may simply include a location identifier that relates to the area of the boundary into which it has entered or from which it has exited. Moreover, the separation of determination of boundary transgression allows for the mobile device to send location entry and exit data to the server system without prior knowledge of whether an issue may or may not exist. In other words, the geo-fenced boundaries may be in place before a related product notification is issued or even contemplated. Only the boundary needs to be previously known to the mobile device; the products, and even classes of products, may be related after the geo-fenced data sets are provided to the mobile device. Alternatively, the mobile device may not know the boundary until it comes in contact with a wireless beacon indicating that the device has entered (or exited) from such a location.

Another embodiment of the current disclosure provides for determining fine details of a geographic location by using Ultra Wideband techniques. The mobile device analyzes time based signals acquired through one or more wideband antennas to determine the physical mapping of the geographic location. These mappings of the physical details of a geographic location can be used to not only provide a three dimensional understanding of the contents and layout of one or more structures at the geographic location but using multiple Ultra-Wideband samples can be used to determine immediate movement or movement over time.

While various embodiments of the present invention have been described above, it should be understood that they have been presented by way of example only, and not of limitation. Likewise, the various diagrams may depict an example architectural or other configuration for the invention, which is provided to aid in understanding the features and functionality that can be included in the invention. The invention is not restricted to the illustrated example architectures or configurations, but the desired features can be implemented using a variety of alternative architectures and configurations.

Indeed, it will be apparent to one of skill in the art how alternative functional configurations can be implemented to implement the desired features of the present invention. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

That which is claimed:

1. A system comprising one or more processors executing programming logic, the programming logic configured to:
store geographic boundary data comprising a plurality of geographic boundary data sets, where each geographic boundary data set indicates the boundaries of a physical space and has or is associated with a location identifier;
receive location data from a network connected device, where the location data comprises data indicating a location of the network connected device and a unique identifier of the network connected device,
determine one or more location identifiers, if any, utilizing the location data and the geographic boundary data, where each location identifier relates to one or more classes, where each class relates to one or more source identifiers;
select one or more notifications, where each notification indicates one or more issues associated with a source identifier, where each source identifier of each notification relates to at least one source identifier related to at least one of the classes related the one or more location identifiers;
assemble an alert utilizing the selected one or more notifications; and
transmit the alert to the network connected device.

2. The system of claim 1, wherein the programming logic is further configured to:
receive the one or more notifications from one or more remote devices.

3. The system of claim 1, wherein the programming logic is further configured to:
obtain the one or more notifications from one or more remote devices.

4. The system of claim 1, wherein the programming logic is further configured to:
transmit location parameters to the network connected device thereby enabling the network connected device to transmit location data based on the location parameters.

5. The system of claim 1, wherein the one or more sources are selected from the group consisting of products and services.

6. The system of claim 1, wherein the programming logic is further configured to:
receive feedback data from the network connected device, where the feedback data comprises a source identifier.

7. The system of claim 1, wherein the programming logic configured to assemble an alert utilizing the selected one or more notifications is further configured to:
withhold from the alert any notifications identified utilizing one or more filter parameters received from the network connected device.

8. The system of claim 1, where each class has a class identifier, wherein the programming logic is further configured to:
receive feedback data from the network connected device, where the feedback data comprises a class identifier.

9. The system of claim 1, wherein the programming logic is further configured to:
receive feedback data from the network connected device, where the feedback data comprises a location identifier.

10. The system of claim 1, wherein the boundaries of a physical space indicated by each geographic boundary data set define a two-dimensional area.

11. The system of claim 1, wherein the boundaries of a physical space indicated by each geographic boundary data set are defined by a polygon with vertices indicated by GPS coordinates.

12. The system of claim 1, wherein the location data further comprises a timestamp, where the timestamp indicates a time, relative or absolute, at which the network connected device was at the location indicated by the location data.

13. The system of claim 1, wherein the programming logic is further configured to:
receive additional location data from the network connected device; and
determine an absence of one or more location identifiers previously determined, if any, utilizing the additional location data and the geographic boundary data.

14. The system of claim 1, wherein the programming logic is further configured to:
receive from a remote device a request to remove a notification; and
remove the notification.

15. A non-transitory computer-readable medium, comprising instructions stored thereon, that when executed on one or more processors, perform the steps of:
receiving geographic location data and a unique identifier from a network connected device;
determining if the geographic location data indicates that the network connected device is within a distance of a certain location, and if so determined, associating the unique identifier of the network connected device with a timestamp and a location identifier, where the location identifier relates to the certain location, where the location identifier relates to one or more classes of sources, and where each class of sources relates to one or more source identifiers;
selecting one or more notifications, where each notification indicates an issue associated with a source identifier, where each source identifier of each notification relates to at least one of the one or more source identifiers related to at least one of the classes of sources related the location identifier related to the certain location; and
transmitting the selected one or more notifications to the network connected device.

16. The non-transitory computer-readable medium of claim 15, wherein the geographic location data comprises GPS coordinates.

17. The non-transitory computer-readable medium of claim 15, wherein the instructions stored thereon, when executed on one or more processors, further perform the step of:
transmitting location parameters to the network connected device thereby enabling the network connected device to transmit location data based on the location parameters.

18. The non-transitory computer-readable medium of claim 15, wherein the instructions stored thereon, when executed on one or more processors, further perform the step of:
receiving additional geographic location data and the unique identifier from the network connected device,
determining if the additional location data indicates that the network connected device is outside the distance of the certain location, and if so determined, associating the unique identifier of the network connected device with a second timestamp and the location identifier.

19. The non-transitory computer-readable medium of claim 18, wherein the instructions stored thereon, when executed on a processor, further perform the step of:
calculating a duration, where the duration is a difference between the timestamp and the second timestamp.

20. The non-transitory computer-readable medium of claim 19, wherein the timestamp and the second timestamp are provided by the network connected device.

21. The non-transitory computer-readable medium of claim 15, wherein the instructions stored thereon, when executed on one or more processors, further perform the steps of:
receiving feedback data from a second network connected device, where the second network connected device has a constant location identifier, where the feedback data comprises a source identifier; and
withholding transmitting to the network connected device any notifications having an associated source identifier that matches the source identifier from the feedback data and having an associated source identifier that is related to at least one of the classes of sources related to the location identifier that matches the constant location identifier.

22. A method of enhanced location-based communications comprising the steps of:
transmitting location parameters to a network connected device, where the location parameters include data indicating when, where, or both when and where location data should be transmitted;
receiving location data from the network connected device;
determining if the location data indicates that the network connected device is within a geographic boundary defined by a geographic boundary data set, where the geographic boundary data set has or is associated with a location identifier;
selecting one or more notifications, where each notification indicates one or more issues associated with a source identifier, where each source identifier of each notification relates to one or more source identifiers of one or more classes of sources, where each class of sources relates to the location identifier; and
transmitting the selected one or more notifications to the network connected device.

23. The method of claim 22, wherein the location parameters comprise a plurality of geographic boundary data sets.

24. The method of claim 22, wherein the location parameters comprise a plurality of proximity data sets, where each proximity data set comprises a location point, a radius, and a transmission rate.

25. The method of claim 22, wherein the location data received from the network connected device comprises the location identifier.

26. The method of claim 22, further comprising the steps of:
receiving feedback data from a second network connected device, where the second network connected device has a constant location identifier, where the feedback data comprises a source identifier; and
withholding transmitting to the network connected device any notifications having an associated source identifier that matches the source identifier from the feedback data and having an associated source identifier that is related to at least one of the classes of sources related to the location identifier that matches the constant location identifier.

27. The method of claim 22, further comprising the step of:
receiving feedback data from the network connected device, where the feedback data comprises a source identifier and the location identifier.
